(19) United States
(12) Patent Application Publication
(10) Pub. No.: US 2008/0252116 A1
(43) Pub. Date: Oct. 16, 2008

(54) Therapeutic Device For Inducing Blood Pressure Modulation

(75) Inventor: Edward H. Phillips, Troy, MI (US)

Correspondence Address: GIFFORD, KRASS, SPRINKLE,ANDERSON & CITKOWSKI, P.C, PO BOX 7021, TROY, MI, 48007-7021, US

(73) Assignee: VBPM, Limited Liability Corporation (LLC), Troy, MI (US)

(21) Appl. No.: 12/134,544

(22) Filed: Jun. 6, 2008

Related U.S. Application Data
(63) Continuation-in-part of application No. 12/108,901, filed on Apr. 24, 2008.
Application No. 12/108,901 is a continuation-in-part of application No. 12/106,534, filed on Apr. 21, 2008.
Application No. 12/106,534 is a continuation-in-part of application No. 11/961,305, filed on Dec. 20, 2007.
Application No. 11/961,305 is a continuation-in-part of application No. 11/775,507, filed on Jul. 10, 2007.
Application No. 11/775,507 is a continuation-in-part of application No. 11/749,505, now abandoned.
(60) Provisional application No. 60/848,740, filed on Oct. 2, 2006.

(51) Int. Cl. A61G 5/00

(52) U.S. Cl. 297/217.1

(57) ABSTRACT

A Kinetic Recliner Chair apparatus intended for use both as a recliner chair and as an apparatus for enhancing blood circulation, and lymph and neural fluid flow throughout a person's body. In order to utilize the apparatus in its therapeutic mode, a person fully reclines a reclining chair member thereof and then activates a controllable motor driven drive mechanism that cyclically tilts the reclining chair member like a seesaw, which action alternatively raises the person's upper torso and head above his or her lower extremities, and vice-versa.

### RELATED PATENTS AND APPLICATIONS

The present application is related to U.S. patent application Ser. No. 11/209,813 filed on Aug. 16, 2005 and entitled “Rhythmic Blood Pressure Modulation and Legshaking Apparatus” that issued on Oct. 2, 2007 as U.S. Pat. No. 7,276,033, which patent (hereinafter the “'033 patent”) is expressly incorporated herein by reference. The present application is also a continuation-in-part of U.S. patent application Ser. No. 12/108,901 filed on Apr. 24, 2008 and entitled “Therapeutic Device for Inducing Blood Pressure Modulation”; which in turn was a continuation-in-part of U.S. patent application Ser. No. 12/106,534 filed on Apr. 21, 2008 and entitled “Therapeutic Device for Inducing Blood Pressure Modulation”; which in turn was a continuation-in-part of U.S. patent application Ser. No. 11/961,305 filed on Dec. 20, 2007 and entitled “Therapeutic Device for Inducing Blood Pressure Modulation”; which was a continuation-in-part of U.S. patent application Ser. No. 11/775,507 filed on Jul. 10, 2007 and also entitled “Therapeutic Device for Inducing Blood Pressure Modulation”; which in turn was a continuation-in-part of U.S. patent application Ser. No. 11/749,505 filed on May 16, 2007 and also entitled “Therapeutic Device for Inducing Blood Pressure Modulation” now abandoned; and claims priority of U.S. Provisional Patent Application Ser. No. 60/848,740 filed on Oct. 2, 2006 and also entitled “Therapeutic Device for Inducing Blood Pressure Modulation”, all of which are incorporated in their entirety herein by reference.

### BACKGROUND OF THE INVENTION

The present invention relates generally to therapeutic devices and, more particularly, to a therapeutic device and a method of use therefor that is believed herein to enhance blood circulation as well as lymph and neural fluid flows throughout a person's body.

Various types of devices have been used for enhancing blood flow through selected portions of human cardiovascular systems. This has been done for the purpose of alleviating various symptoms associated with different types of diseases or conditions. For example, enhanced external counter-pulsation (hereinafter “EECP”) utilizes pressure cuffs around various portions of a person's lower extremities and buttocks. The pressure cuffs are sequentially and abruptly inflated and then deflated in sync with the person's heart rate such as to implement a reverse pulsation of blood flow back toward the person's upper torso and head immediately following systole. This results in pressure spikes of as much as 50 mmHg being imposed upon any partial arterial blockages that may be present in those portions of the person's body, and may in fact enable formation of collateral circulation passages around such partial blockages. In order to be effective, EECP is typically administered to a person over a series of 35 one-hour treatments during a seven-week period. During their abrupt inflation the pressure cuffs can often inflict significant discomfort in the person however, thereby causing him or her to be distressed and perhaps counteracting the therapeutic effect for which the device was intended. Furthermore, there has apparently been no suggestion that EECP is helpful in promoting enhancement of either lymph or neural fluid flows within the human body.

Another device was described in a book entitled “Surgical Nursing” by Eliason, Ferguson and Farrand and published as early as 1929 by the J.B. Lippincott Company. It was called a “Sander's oscillating bed for treatment of peripheral vascular disease”. In describing the Sander's oscillating bed and its use the authors stated the following:

“The Sander's oscillating bed is a method of administering passive exercises to allow intermittent filling and emptying of capillaries, venules and arterioles. The bed is set upon a rocker operated by a motor so that it tilts on its long axis at regular intervals. The intervals may be adjusted according to the needs of the patient and the wishes of the physician. This method of administering passive postural exercises may be carried out day and night and is claimed by some to have produced relief of the rest pain and of the pain associated with ulcers and gangrene. It may be used not only in arteriosclerosis and thrombo-angitis obliterans but also in minor degrees of arterial embolism.”

The Sander's oscillating bed was also described in the Aug. 4, 1951 issue of the Journal of the American Medical Association as being utilized at “high frequency” as a “vasoscillator”—thus implying that it was useful for dilating clogged blood vessels. It is believed herein that when it was utilized for this purpose, the Sander's oscillating bed was driven at a relatively high frequency significantly beyond 20 cycles/minute. On the other hand, other articles published during the 1950s detailed its use for augmenting ventilation in patients with poliomyelitis. This was obtained via internal manipulation of the patient's lungs obtained as a result of alternating gravitational forces cyclically displacing the patient's intestines such as to cyclically elevate and depress his or her diaphragm. In this case, the Sander's oscillating bed was driven at a “relatively low frequency” of perhaps 20 cycles/minute that was considered to be compatible with a normal rate of breathing.

As will be fully explained below, it is believed herein that operation of such a bed at the high frequencies noted above would be grossly inappropriate. First of all, it would most likely induce discomfort in the patient. More significantly, there would be insufficient time to substantially drain pooled venous blood from selected portions of a person's venous system during the portion of each cycle when they are subject to pressure values lower than atmospheric pressure, or later during the cycle, to totally fill the veins comprised in those portions of the person's venous system with new venous blood coming from associated arterioles, capillaries and venules—when otherwise those veins would have dilated and become subject to pressure values greater than atmospheric pressure. Thus, implementation of even the basic concept of venous blood pressure modulation as explained below would not be possible on a Sander's oscillating bed operated at the high frequencies noted above. But as is also explained below and perhaps in some cases of even more significance, such high frequency operation would be totally incompatible with enhancing operation of a person's lymph system.

Further, it is also believed herein that all versions of the Sander's oscillating bed were implemented with a flat (e.g., planar) bed and, as implied above, “set upon a rocker operated by a motor so that it tilts on its long axis at regular intervals”. Because of such construction, it is also believed herein that shoulder and/or foot constraints were typically utilized for longitudinally restraining patients so that they wouldn't slide “up or down” excessively. It is believed herein that use of such artificial shoulder and foot constraints would also tend to induce discomfort in the patient. Perhaps because of the requirement for such artificial constraints, or because of the above explained high frequency misapplication in its use, or even simple patient discomfort associated with the high frequency operation, or because of safety concerns relating to the open rocker construction, the Sander's oscillating bed obviously fell out of favor.

An alternate type of therapeutic device that includes a bench or support member upon which a person can lie down is described in detail in U.S. Pat. No. 6,261,250. Harnesses are attached to each arm and leg of the person. The harnesses are attached to cables actuated by a gearmotor in a manner that cyclically and synchronously raises and lowers all of the person's limbs. The change in elevation of the person's limbs causes a moderate modulation of blood pressure in both of the arterial and venous networks of the person's cardiovascular system. Although it runs at a cyclic rate of slightly over 20 times/minute, this therapeutic device is none-the-less believed to be somewhat effective in enhancing blood flow throughout the person's circulatory system, including his or her coronary system as well as in his or her brain. In addition, it is also believed to be somewhat effective in enhancing neural fluid flow within the person's body generally, and particularly in the brain. However, it does require an amount of coordinated muscle activity on the person's part to properly position him- or her-self on the bench and maintain his or her limbs within the harnesses, as well as to properly interact with the device. For some people, such interactions can be stressful and could even somewhat counteract the therapeutic effect for which the device is intended. Furthermore, the therapeutic device depicted in the '250 patent comprises an open counter-balanced flywheel that for safety reasons would obviously be of concern.

Patent applications '305 and '507 provide detail descriptions of an improved therapeutic method and self-operated therapeutic device for inducing blood pressure modulation therapy (hereinafter “BPM therapy”) now commonly referred to as a Kinetic Recliner Bed. Utilization of the Kinetic Recliner Bed in accordance with the preferred methods described in patent applications '305 and '507 has been shown to provide numerous therapeutic benefits resulting from enhanced blood, lymph and neural fluid flows in a person's body and brain. The person places him or herself in a generally supine position on a support member of the Kinetic Recliner Bed, such as a bed or table (hereinafter “bed member”) formed in a contoured manner whereupon he or she can comfortably lie without artificial constraints. A drive mechanism is used to cyclically move the bed member in a seesaw manner in order to elevate the person's upper torso and head above his or her lower extremities, and then to elevate the person's lower extremities above his or her upper torso and head. The cyclical rate of motion of the bed member is preferably about 6 cycles/minute and its total angular range of motion relative to its nominally centered horizontal position is preferably around 30°.

Operationally, the Kinetic Recliner Bed and its preferred BPM therapy method of utilization are satisfactory in every way. The Kinetic Recliner Bed is robust and quite reliable in operation, and is thus suitable for continuous use in clinical applications. However, it is heavy (i.e., about 330 pounds), somewhat complex, relatively expensive, and as a practical matter, must be shipped in two containers. Furthermore, a two-person assembly team is required for its installation and final assembly on site in a dedicated space measuring at least 5 feet by 8 feet. These factors have combined to render private in-home use of the Kinetic Recliner Bed by average individuals somewhat problematic. What is needed is an in-home model that is lighter, simpler and less expensive. Additionally, the in-home model should be configured such that it also can function as a recliner chair and thus be utilized in virtually any person's living quarters.

It is important to understand that utilization of any of these example therapeutic devices does not impose a medically oriented treatment upon a person similarly to that such as he or she would typically experience via utilizing invasive types of treatment provided by a medically licensed physician through his or her prescription of medication, or by execution of a surgical procedure. Rather, their use is generally non-invasive in nature, and with the exception of EECP, any person could use them in a self-operated manner at his or her own volition. Alternately of course, such self-operated apparatus could also be utilized with the assistance of an alternative medicine practitioner, or even at the suggestion of a medically licensed physician. Their use by any person can most accurately be described as that of non-invasively conditioning that person in a manner essentially similar to him or her exercising on exercise apparatus in a gym, so that his or her body could be enabled for improving, or even possibly for curing, itself.

### SUMMARY OF THE INVENTION

The preferred embodiment of the present invention relates to another improved self-operated therapeutic device for inducing BPM therapy (hereinafter referred to either as a “Kinetic Recliner Chair” or more simply as a “recliner chair”) that is lighter, simpler and significantly less expensive than the professional Kinetic Recliner Bed described above, but still able to implement the same therapeutic method and provide substantially the same therapeutic benefits. In addition, the Kinetic Recliner Chair is configured such that it can also function as a recliner chair and can thus be utilized in any person's living quarters. Thus in utilizing the Kinetic Recliner Chair in place of a standard recliner chair, a person would first sit down on a reclining chair portion thereof (e.g., with it disposed in an upright manner) and then sequentially manipulate hand operated ottoman elevating and extending apparatus that elevate and extend an ottoman portion thereof, and of course, suitably support his or her lower extremities. Then if desired, the person would manipulate a hand operated chair reclining apparatus in order to move the reclining chair and him or herself into any desired reclined position. Finally, if the person wishes utilize the recliner chair therapeutically in the above described seesaw manner, he or she would continue to manipulate a hand operated chair reclining apparatus until the fully reclined position is reached whereat the reclining chair is in this final fully reclined position. In so doing, the person has in fact disposed him or herself in a substantially identical nominally supine position (hereinafter “supine position”) as he or she would experience on the professional Kinetic Recliner Bed in its head and upper torso elevated position.

The supine position is the necessary starting position for activating the recliner chair in a substantially identical cyclical rocking motion as the one that is operationally achieved by the bed member of the professional Kinetic Recliner Bed. This cyclical rocking motion is then implemented in the seesaw manner by a comprised drive mechanism so that the person is cyclically tilted from an upper torso and head-elevated position to a lower extremities-elevated position and vice-versa.

As with the professional Kinetic Recliner Bed, it has been anecdotally observed that desired therapeutic blood, lymph and neural fluid flow enhancing effects of BPM therapy are optimized when the person assumes a mentally relaxed state, and optimally so, when he or she is able to fall into a sleep state during cyclical operation of the recliner chair. Further, because the person's dominant weight supporting points are continually moving between different areas of his or her buttocks and lower torso as a function of instant tilt angles obtained during the rocking motion of the recliner chair, it has been anecdotally observed that the phenomenon of forming bed sores is highly unlikely or even impossible, irregardless of how long the person remains on the rocking recliner chair. As with the Kinetic Recliner Bed, the preferred cyclical rate of motion for the recliner chair is about 6 cycles/minute and its total angular range of motion is around 30°.

Again, it should be emphasized that utilization of the recliner chair does not impose a medically oriented treatment upon a person similarly to that such as he or she would typically experience via utilizing invasive types of treatment provided by a medically licensed physician through his or her prescription of medication, or by executing a surgical procedure. Rather, its use is generally non-invasive in nature and can be used by any person at his or her own volition. Alternately of course, it can be utilized with the assistance of an alternative medicine practitioner, or even at the suggestion of a medically licensed physician. In fact, its use by any person can more accurately be described as that of non-invasively conditioning that person so that his or her body can be enabled for improving, or even possibly for curing, itself.

Other benefits, features and aspects of the present invention will become apparent from a review of the following description of preferred embodiments, when viewed in accordance with the attached drawings and appended claims.

### BRIEF DESCRIPTION OF THE DRAWINGS

FIGS. 1A, 1B and 1C are side views illustrating the range of motion of a recliner chair configured in accordance with the preferred embodiment of the present invention.

FIG. 2 is a schematic view of the cardiovascular circulatory system.

FIG. 3 is a schematic view of a greatly enlarged minute portion of a capillary bed.

FIG. 4 is a schematic view of a lymph collector.

FIGS. 5A and 5B are schematic views of a lymph pre-collector.

FIGS. 6A and 6B are side views depicting a recliner chair configured in accordance with the preferred embodiment of the present invention and shown in upright and reclined positions, respectively.

FIG. 7 is a sectional view of operative portions of a hand operated rotational assembly utilized for manipulating the recliner chair of FIGS. 6A and 6B.

FIG. 8 is an overall perspective view of an ottoman elevating mechanism utilized in the recliner chair of FIGS. 6A and 6B.

FIG. 9 is a sectional plan view of an ottoman extending mechanism utilized in the recliner chair of FIGS. 6A and 6B.

FIG. 10 is a flow chart that illustrates a method of controlling a recliner chair comprising a servo drive mechanism but otherwise similar in function the that shown in FIGS. 6A and 6B.

FIG. 11 is a perspective view of an example drive mechanism for cyclically moving the recliner chair shown in FIGS. 6A and 6B.

FIG. 12 is a flow chart that illustrates a preferred example therapeutic method intended for enhancing blood, lymph and neural fluid flows in a human body and brain in accordance with the present invention.

### DETAILED DESCRIPTION OF THE PREFERRED EMBODIMENTS

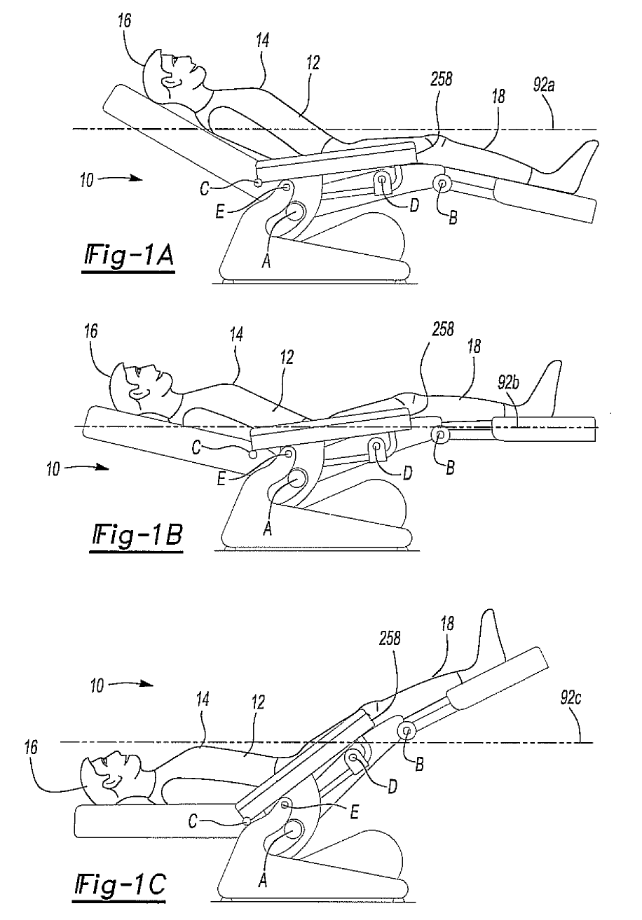

FIGS. 1A, 1B and 1C are side views illustrating the range of motion of an example generic Kinetic Recliner Chair 10 (hereinafter “recliner chair 10”) wherein FIG. 1A depicts an initial portion of its cycle of operation whereat a person 12's upper torso 14 and head 16 (hereinafter “upper torso and head 14/16”) are elevated; FIG. 1B depicts the portions of the cycle whereat the person 12 is disposed in a nominally horizontal position; and FIG. 1C depicts the portion of the cycle whereat the person 12's lower extremities 18 are elevated. As set forth elsewhere herein, the preferred cyclical rate of motion for the recliner chair 10 is about 6 cycles/minute and its total angular range of motion is around 30°.

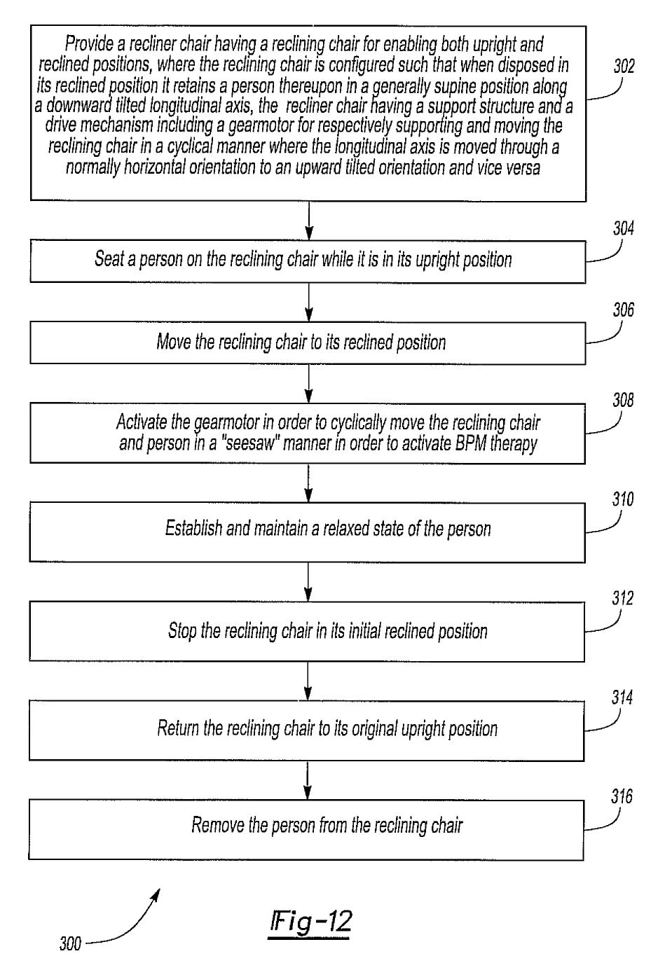

When used in accordance with a preferred example BPM therapy method (i.e., hereinafter “BPM therapy method 300” as described below and depicted in FIG. 12), it is hypothesized to provide enhanced blood, lymph and neural fluid flows in the human body and brain. In some anecdotal examples, utilization of the recliner chair 10 has been helpful for enabling an improved quality of life for persons having various types of physical and neural diseases or conditions such as Parkinson's disease, Alzheimer's disease, essential tremor, muscular dystrophy, autism, migraine headaches, traumatic brain injuries, varicose veins, fibromyalgia, drug addiction, and diabetes related problems such as high glucose count, impaired circulation, neuropathy, open wounds, and lymphedema with abnormal tissue swelling. In order to develop an understanding of the why utilization of the recline chair 10 is believed herein to be so operative, it is useful to first explore the machine's operation in relation to an in depth understanding of the functioning of the human circulatory and lymph systems.

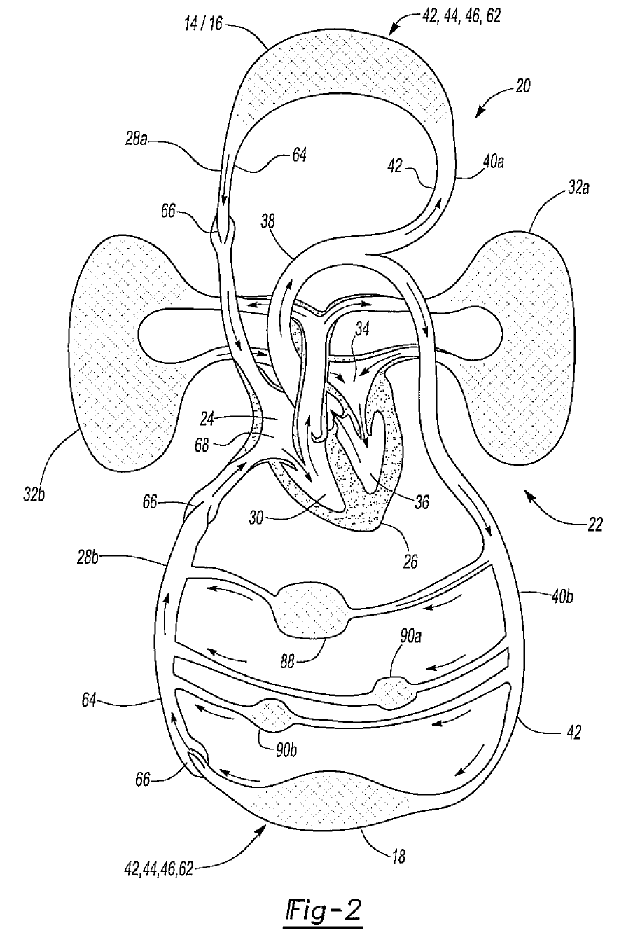

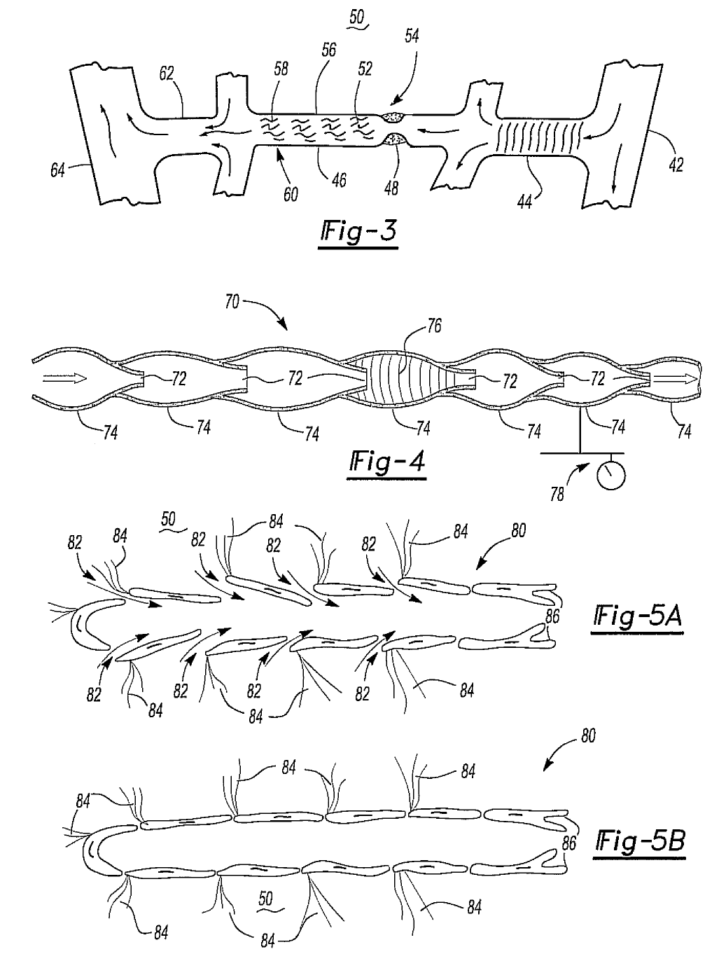

FIG. 2 depicts a human circulatory system 20 in a highly simplified schematic manner. The cardio-pulmonary portion 22 of the human circulatory system 20 includes the right atrium 24 of the heart 26 receiving oxygen-depleted blood from upper and lower body venous networks 28a and 28b (hereinafter “venous system 28a/28b”), pumping it via the right ventricle 30 through left and right lungs 32a and 32b wherein carbon dioxide is exchanged for oxygen, then on to the left atrium 34 and ventricle 36 of the heart 26 from where the now oxygen-rich blood is pumped into the aorta 38, and from there to the upper and lower body arterial networks 40a and 40b (hereinafter “arterial system 40a/40b”). The arterial system 40a/40b comprises an enormous multitude of ever-finer arteries 42 and arterioles 44 that convey the oxygen-rich blood from the heart 26 to a truly extraordinary multitude of perhaps a billion or more capillaries 46 (i.e., with one set thereof being shown in a highly simplified schematic manner in FIG. 3).

Layers of smooth spirally oriented muscle cells (not shown) are comprised in the arteries 42. They serve to maintain finite values of arterial blood pressure between systolic events. Similar but much finer layers of smooth spirally oriented muscle cells (also not shown) are also comprised in the arterioles 44. These finer layers of smooth spirally oriented muscle cells are utilized by a cardiovascular control center (not shown) in the brain for selectively controlling arteriole size and thus blood flow resistance. Further as illustrated in the highly magnified schematic view of FIG. 3, a pre-capillary sphincter 48 protects each capillary 46. The pre-capillary sphincters 48 are utilized by the cardiovascular control center for selectively maintaining instant proportions of the capillaries 46 that are open to blood flow at any particular time in any portion of the body. These factors permit the brain to execute an almost incomprehensibly complex task of regulating blood flow throughout the cardiovascular system 20 as well as controlling instant blood pressure values and selectively servicing trauma of any type (i.e., including minor trauma such as a cut or scrape).

Additionally, the brain indirectly controls heart rate via generating neural inputs to sympathetic and parasympathetic nerve fibers (not shown) in the heart 26. Although the complexity of this control system is truly amazing, it has a rather slow response time. One indication of this slowness is the length of time (i.e., in the order of a minute or more) for a minor scrape to be serviced by the arrival of fresh blood that occurs via the opening of a multitude of juxtaposed pre-capillary sphincters 48. As described below, this slowness in response time relative to the preferred cyclical rate of motion of about 6 cycles/minute (e.g., for the recliner chair 10) is important with respect to utilization of the BPM therapy method 300.

As will be discussed in greater detail below, blood flows through the open ones of the capillaries 46 wherefrom oxygen, sugar and protein bearing plasma flows into surrounding interstitial space 50 through micro-pores 52 located near the moderately pressurized arteriole/sphincter ends 54 of the capillary walls 56. Carbon dioxide and waste bearing plasma then flows back into the capillaries 46 via osmosis generated pressure through other micro-pores 58 located near the downstream or venule ends 60 of the capillary walls 56. Finally, the then oxygen depleted blood flows through venules 62 and into the venous system 28a/28b, which venous system 28a/28b acts as a reservoir containing about 65% of the body's total blood volume.

As shown schematically in FIG. 2, the larger veins 64 of the venous system 28a/28b comprise sequentially spaced semi-lunar folds that function as one-way check valves 66. The check valves 66 serve to preclude reverse flow back toward the venules 62 and capillaries 46. Generally the veins 64 and venules 62 of the venous system 28a/28b are simpler and more compliant than the arteries 42 and arterioles 44 of the arterial system 40a/40b. However, they also include layers of smooth spirally oriented muscle cells that (e.g., at least in the larger ones of the veins 64) are utilized by the cardiovascular control center for regulating their circumferential size. This involves the brain and body continuously executing a very complex and precise servo control of the volumetric size of the venous system 28a/28b as a whole, which servo control function also has a fairly long implementation time constant (e.g., longer than a single cycle of operation of the recliner chair 10). The volumetric size of the venous system 28a/28b is controlled such that average venous blood pressure at the entrance to the heart 26 is maintained at a level just slightly above atmospheric pressure in response to signals emanating from a cardiopulmonary mechanoreceptor 68 located in the right atrium 24 of the heart 26. This results in average venous blood pressure being maintained at a zero value relative to atmospheric pressure at a horizontal plane 92 (e.g., shown in FIGS. 1A, 1B and 1C as zero venous pressure planes 92a, 92b and 92c) located a few inches thereabove (generically hereinafter referred to as the “zero venous pressure plane 92”).

As a result, venous blood pressure present at any particular point within a person's venous system can be determined by the formula

P_{V}=1.875h (1)

where P_{V} is the difference between venous blood pressure at that particular point and atmospheric pressure (in mmHg), and h is the vertical distance between that particular point and the vertical position of the zero venous pressure plane 92 (in inches). Thus, portions of the venous system 28a/28b that are instantly positioned vertically below the zero venous pressure plane 92 have positive pressure (e.g., relative to atmospheric or zero pressure) whereby there is a positive differential pressure value imposed between them and the outside of a person's body (not shown). On the other hand, portions of the venous system 28a/28b that are instantly positioned vertically above the zero venous pressure plane 92 have negative pressure whereby there is a positive differential pressure value imposed between the outside of the person's body and those portions of the venous system 28a/28b. This compresses those veins 64 and causes previously “pooled” venous blood contained therein to “drain” back toward the heart 26 (e.g., with the venous blood freely moving through the above described check valves 66) with the result that those veins 64 are compressed or even somewhat flattened out.

Then later in the cyclic motion of the recliner chair 10 when those portions of the venous system are again positioned below the zero venous pressure plane 92, they fill with oxygen depleted blood flowing from juxtaposed capillaries 46 and venules 62 (e.g., not back down through the larger veins 64 themselves because of the one-way flow nature of the check valves 66) and expand. In either of these cases, it is believed herein that it is necessary to provide adequate time for allowing these “draining and filling” functions to substantially occur. Thus while the preferred cyclic rate of operation of about 6 cycles/minute is believed to be sufficiently quicker than the above described slowness in cardiovascular system response time to retain a substantially constant venous system volume, it is also believed to be slow enough to substantially allow the also described “draining and filling” functions to occur.

The above described general principle can be demonstrated by observing what happens to a visible peripheral vein running along the back of one's hand and arm as that hand and arm are slowly raised toward shoulder height. Portions of that vein will soften and contract, and even begin to flatten out as they reach shoulder height and then remain flattened while they are above that height. Then if one rapidly lowers the hand and arm he or she will observe a tendency for the veins 64 to fill “from the bottom”. It is believed herein that substantially the same actions occur within the fine venous system structures comprised in the upper torso and head 14/16, and also within the lower extremities of a person whenever he or she is supinely disposed upon a cyclically moving recliner chair 10.

Concomitantly, the arterial blood pressure present at any particular point within a person's venous system can be determined by the formula

Pₐ=Pₒ+1.875h (2)

where Pₐ is the difference between arterial blood pressure at that particular point and atmospheric pressure (in mmHg), Pₒ is instantaneous arterial blood pressure at his or her zero venous pressure plane 92 (in mmHg), and h is the vertical distance between that particular point and the vertical position of his or her zero venous pressure plane 92 (in inches). Thus, portions of the arterial system 40a/40b that are instantly positioned vertically below the zero venous pressure plane 92 have increased positive pressure. On the other hand, portions of the arterial system 40a/40b that are instantly positioned vertically above the zero venous pressure plane 92 have reduced positive pressure.

Such variations of the arterial and venous blood pressures are illustrated in FIGS. 1A, 1B and 1C for a person 12 disposed on the recliner chair 10. Again, FIG. 1A depicts the initial portion of its cycle of operation whereat the person 12's upper torso and head 14/16 are elevated; FIG. 2B depicts the portions of the cycle whereat the person 12 is disposed in a nominally horizontal position; and FIG. 1C depicts the portion of the cycle whereat the person 12's lower extremities 18 are elevated. Of these, the nominally horizontal position depicted in FIG. 2B can logically be said to approximate the average disposition of the person 12 when he or she is disposed upon the cyclically moving recliner chair 10.

Thus in FIGS. 1A, 1B and 1C instantaneous locations of the zero venous pressure plane 92 can be approximated by a zero venous pressure plane 92b passing through the upper torso 14 of the nominally horizontally disposed person 12 depicted in FIG. 1B whereby portions of the venous system above and below the zero venous pressure plane 92b are respectively subject to negative and positive pressure values. Zero venous pressure planes 92a and 92c respectively depicted in FIGS. 1A and 1C similarly define instantaneous locations of the zero venous pressure plane at the extremes of cyclical motion of the recliner chair 10. Thus the person 12's upper torso and head 14/16 are subject to alternating negative and then positive pressure values, even as his or her lower extremities 18 are concomitantly subject to alternating positive and then negative pressure values. Again, this occurs as a result of the above noted inability of the venous volumetric control system to quickly respond within the preferred 6 cycle/minute operational frequency of the recliner chair 10.

Gravitational forces resulting from alternating cyclical elevation of the person 12's upper torso and head 14/16, and then lower extremities 18 rhythmically modulate both the instantaneous arterial and venous blood pressures in the upper torso and head 14/16, and the lower extremities 18, over a range of perhaps 20-30 mmHg in accord with equations (1) and (2) above. Thus when the upper torso and head 14/16, and alternately the lower extremities 18, attain peak elevation above zero venous pressure planes 92a or 92c as respectively depicted in FIGS. 1A and 1C, arterial blood pressure in those portions of the person 12's body is lowered by up to 15 mmHg while venous blood pressure in those portions of the person 12's body is lowered below atmospheric pressure to perhaps a negative value of as much as −15 mmHg. As a result, there is then a pressure differential of as much as 15 mmHg between atmospheric pressure externally impressed upon the person 12's body and the venous blood pressure within those portions of the his or her body. As explained above, this pressure imbalance forces the surrounding tissue to somewhat compress or shrink those portions of the venous system 28a/28b, and of course, forces venous blood to flow from those veins 64 generally toward the heart 26 (again, this phenomenon is responsible for the observed flattening of peripheral veins 64 in a person's hand and forearm as he or she raises that arm).

On the other hand, as the upper torso and head 14/16, or alternately, the lower extremities 18 are lowered as respectively depicted in FIGS. 1C and 1A, arterial pressure values in those portions of the person 12's body rise in the head 16 by perhaps up to 10 mmHg and alternately in the lower extremities 18 by perhaps up to 20 mmHg above the instantaneous values present at the zero venous pressure planes 92c or 92a. Corresponding increases in venous blood pressure values lag behind because those veins 64 must first “fill up” with new venous blood issuing from their associated artery and arteriole fed capillaries 46 and venules 62. Similarly, arterial and venous blood pressures in the remaining portions of the person 12's body are subject to continuous modulation at lesser values.

As described in a book entitled “Exercise Physiology” by William D. McArdle, Frank I. Katch and Victor L. Katch and published by Williams & Wilkins of Baltimore, Md. and Media, Pa. (and again with reference to FIG. 3 herein) arterial pressure decreases by about 20% of the average value it had in the aorta by the time the arterial blood reaches the arterioles 44 and further decreases by perhaps another 35% as it passes through the arterioles 44. Further, the cyclic variation between systolic and diastolic pressures that is generally present in the arterial system 40a/40b pretty well dies out by the time the blood passes through the arterioles 44. Thus ignoring the gravity effects described elsewhere herein, blood pressure entering the arteriole/sphincter ends 54 of the capillaries 46 has a value of about 45% of the average arterial pressure present in juxtaposed portions of the arterial system 40a/40b. Then also ignoring the above described transient effect relating to the delayed filling of the veins 64, the pressure decreases by about another 25% as is passes through the capillaries 46 (and as a parallel flow of plasma through the serial combination of the micro-pores 52, interstitial space 50 and micro-pores 56). The transient effects could amount to as much as another 10% pressure drop or perhaps as much as a transient 40% increase in driving pressure through the capillaries 46 and the serial combination of the micro-pores 52, interstitial space 50 and micro-pores 56. In addition, the driving pressure through the serial combination of the micro-pores 52, interstitial space 50 and micro-pores 56 is further assisted by osmotically generated supplemental pressure present at least at the micro-pores 56.

In general and especially in view of the compliant nature of the surrounding tissue itself, all of these factors result in a rather complex modulation of interstitial fluid volume and pressure as a function of the cyclic motion of the recliner chair 10. Generally the interstitial space 50 will vary between having a slightly swollen, pressurized condition when a portion of a person's anatomy is lowered and a somewhat shrunken non-pressurized condition when it is elevated. The point of all of this is that interstitial space volume and pressure will vary cyclically in a rather erratic yet synchronized (e.g., with the motion of the recliner chair 10) manner at a frequency of about 6 cycles/minute. Further, it is also apparent that the pressure drop across the various comprised flow channels and orifices varies in a similarly erratic yet synchronized manner as well. It is believed that these actions result in a general massaging of the tissue and a tendency to break up any blockages present in the flow channels and orifices.

Again, pressure present within the arteriole/sphincter ends 54 of the capillaries 46 is sufficient to drive plasma comprising oxygen, sugars, protein, fat and doubtless other material into the surrounding interstitial space 50 through the first encountered micro-pores 52 as entering interstitial fluid that enables oxygen and nutrient to be delivered to the tissue. Then generally, the interstitial fluid “morphs” via the oxygen/carbon dioxide exchange as well as through most of the other materials being replaced by waste products. As noted above, fluid pressure values at the venule ends 58 of the capillaries 46 are normally low enough to allow osmotic pressure to drive most of the interstitial fluid back into those capillaries 46 via the micro-pores 56. However, the remaining excess interstitial fluid (i.e., comprising some of the excess protein, fat and other waste material) is normally removed by a person's lymph system.

As described in detail in a book entitled “Silent Waves, Theory and Practice of Lymph Drainage Therapy” by Bruno Chickly, M.D., D.O. (hon) and published by International Health & Healing Inc. Publishing of Scottsdale, Ariz., the lymph system is a secondary circulatory system that normally implements a one-way flow of the excess protein, fat and other waste bearing material (i.e., as lymph fluid) generally upwards from the interstitial space 50 through various lymph flow channels toward the right lymphatic and thoracic ducts (not shown). These ducts then drain the lymph fluid into the circulatory system at the right and left subclavian veins (also not shown), and then pass the assimilated lymph fluid sequentially through the right side of the heart 26, the lungs 32a/b, the left side of the heart 26, and finally, to the liver 88 and/or kidneys 90 for processing and proper elimination.

As depicted schematically in FIG. 4, one-way flows of lymph fluids within the lymph system generally pass through a multitude of lymph collectors 70 each comprising closely spaced sequential one-way valves 72 (i.e., similar but much smaller than those found in veins 64) interconnected by very short segments of lymphatic vessels 74 called lymphangions (hereinafter “lymphangions 74”). The lymphangions 74 are only about 6 to 20 mm long (i.e., as described in “The Genetic History of the Valves in the Lymphatic System of Man”, by O. F. Kampmeir, Am. J. Anat. 1928, 40:413-457). They comprise spiral muscle layers 76 that contract involuntarily in response to innervation signals issuing from the person's autonomic nervous system as indicated schematically at numeric indicator 78.

When a person is at rest, the rate of such contractions normally occurs at about 5 to 8 cycles/minute (i.e., as described in “Intrinsic Contractility of Leg Lymphatics in Man: Preliminary Communication”, by W. L. Olszewski et. al., Lymphol, 1979, 12: 81-84: and “Intrinsic Contractility of Prenodal Lymph Vessels and Lymph Flow in Human Leg” by W. L. Olszewski et. al., Am. J. Physiol, 1980, 239:775-783). In so doing, the combinations of sequential one-way valves 72, lymphangions 74, and spiral muscle layers 76 act as pumping mechanisms that serve to force the lymph fluid through the valves 72 and on to the right lymphatic and thoracic ducts—thus moving the one-way flow of excess protein, fat and other waste bearing lymph fluid generally upwards through the person's lymphatic flow channels and eventually on to the right and left subclavian veins as described above.

As depicted schematically in FIGS. 5A and 5B, excess interstitial fluid first becomes lymph fluid by entering minute lymph capillaries (not shown) formed like cul-de-sacs and located in extra cellular spaces surrounding each one of an enormous multitude of lymph pre-collectors 80. As shown in FIG. 5A, the lymph fluid next enters the lymph pre-collectors 80 through open junction ends 82 whenever the fluid pressure in the pre-collectors 80 is less than that present in the minute lymph capillaries, and of course, juxtaposed interstitial space 50. Anchoring filaments 84 help to open the junction ends 82 widely whenever that differential fluid pressure becomes significant. The lymph fluid next enters juxtaposed lymphangions 74 via lymphatic bicuspid valves 86.

On the other hand, whenever the fluid pressure in the pre-collectors 80 is more than that present in the minute lymph capillaries, the junction ends 82 immediately close as shown in FIG. 5B in order to prevent back flow of lymph fluid into the minute lymph capillaries. Similarly, the lymphatic bicuspid valves 86 are closed by inverse differential fluid pressure whenever higher pressure is present in the juxtaposed lymphangions 74 in order to preclude lymph fluid back flow into the lymph pre-collectors 80.

Should any of the veins 64 be subject to continuous increased pressure values (i.e., such those in one's feet while on a long airplane trip) the normal osmotic flow of interstitial fluid back into juxtaposed capillaries 46 via the micro-pores 56 will be somewhat impeded. This will tend to increase interstitial space pressure and volume, and in turn, will attempt to promote increased lymph fluid flow into the minute lymph capillaries and lymph pre-collectors 80. But because of a concomitant increase of lymph system backpressure (i.e., also due to gravity effects), the normal upward one-way flow of lymph fluid will also be impeded. As a result, lymph fluid will tend to back up. This, in combination with the increased pressure in those veins 64 as well as juxtaposed arteries 42, results in a significant increase of interstitial pressure, and as a result, an increase in the volume of fluid trapped in the interstitial spaces 50 therein comprised. These phenomena coupled with some swelling of juxtaposed arteries 42 and veins 64 are responsible for the feet swelling during prolonged airplane trips.

Generally, lymph fluid movement occurs slowly and sometimes problematically at volumetric rates of up to only about 4 liters/day with nominal differential driving pressures of only 1 to 2 mmHg above surrounding interstitial space 50 provided by the smooth spirally oriented muscle layer 76 of each lymphangion 74. Blockages can occur—often as a result of trauma or surgery. Such blockages can cause abnormally high intralymphatic pressures and excessively dilated lymphangions 74, which in turn result in juxtaposed ones of the valves 72 becoming incompetent. This allows lymph fluid to flow backwards, and in turn, causes “upstream” lymphangions 74 to excessively dilate with more valves 72 then becoming incompetent. This incompetency is then transmitted back to the lymphatic bicuspid valves 86 and finally to the junction ends 82, with lymph fluid then flowing back into the interstitial space 50. The result is an accumulation of lymph fluid in the interstitial space 50 and thus, lymphedema with abnormal tissue swelling.

It is interesting to note that the recliner chair 10's preferred operational frequency of about 6 cycles/minute falls within the above noted typical resting lymphangion spiral muscle contraction rate of 5 to 8 cycles/minute. It is hypothesized herein that the calming action of the BPM therapy method 300 typically causes a person's parasympathetic nervous system to become dominant over his or her sympathetic nervous system and slow his or her lymphangion spiral muscle contraction rate to a synchronously matching (e.g., with the recliner chair 10) contraction rate of approximately 6 cycles/minute and “lock” thereto in a phase locked manner.

As a result, it is hypothesized that when the lower extremities are elevated, a significantly more efficient “upward” one-way flow of lymph fluid occurs through the lymphangions 74 because the force of gravity then assists the lymphangion spiral muscle layer contraction in driving the lymph fluid “upward”. It is further hypothesized that this results in significantly lowered pressure values in “upstream” lower extremity lymphangions 74, and juxtaposed lymph pre-collectors 80 and lymph capillaries. Then when the lower extremities are lowered and their interstitial spaces 50 are subject to a slightly increased volume and positive pressure, it is still further hypothesized that entry of interstitial fluid into the lymph capillaries, lymph pre-collectors 80 and juxtaposed lymphangions 74 is enhanced thereby increasing incoming lymph flow volume.

Such an improvement in lymph system function has been anecdotally observed in case studies wherein a relatively rapid reversal of lymphedema with abnormal tissue swelling has occurred in conjunction with utilizing the recliner chair 10. This is believed to have occurred in part as a result of the above-described cyclic tissue compression and relaxation clearing an effected person's problematic lymphatic flow channel blockages—and also in part as a result of an increased flow of lymph fluid implemented by that person's lymphangion spiral muscle rate locking on to the approximately 6 cycles/minute cyclic operational frequency in the also above-described phase locked manner. Thus, it is believed herein that lymph circulation is significantly enhanced via utilization of the BPM therapy method 300.

The cyclic motion of the recliner chair 10 also modulates the venous blood pressure present at the entrance to the heart 26 between positive and negative values—perhaps with an average offset toward the positive values. This results in a modulation of venous return to the heart 26 that in turn leads to a modulation of cardiac output. This is because the charge volume of venous blood entering the heart 26 is largely a function of the cyclically varying venous blood pressure at the entrance to the heart 26. Thus blood flow and blood pressure tend to increase during periods when the head and torso are lowered and decrease when the head and torso are elevated. It is thought by some that this modulation of cardiac output might result an increase in arterial generation of the vasodilator NO₂ commonly called nitric oxide (but perhaps more correctly referred to as nitrogen dioxide). It is thought that this could lead to a general dilation of the arterial system (hereinafter “vasodilation”) and perhaps an improved delivery of blood and nutrients throughout the body. Specifically, it is thought that this might be a factor in the anecdotally observed reversal of neuropathy and/or open wound healing.

Additionally, it is also believed herein that the above-described working of tissue constitutes an internally generated form of exercise that consumes and converts chemical energy derived from nutrients present in the blood into heat on a micro level thereby increasing metabolism. A person can readily demonstrate this concept as follows:

While leaving one hand immobile, that person cyclically elevates and then lowers the other at a rate of about 6 cycles/minute for a couple of minutes. If the palms of both hands are than put on the cheeks he or she will find that the one that was elevated and lowered is considerably warmer than the one that was left immobile—even though it had been gorged with venous blood. Further, he or she will likely experience a significant tingling sensation in the elevated and lowered hand.

Finally then, a listing of the hypothesized mechanisms active in conjunction with utilization of the BPM therapy method 300 includes the cyclic manipulation of interstitial fluid volume and pressure, the improved lymph system function, the modulation of cardiac output with the perhaps associated general arterial system vasodilation, the likely increase in metabolism resulting from the internally generated form of exercise, and the shrinking and swelling of the arteries 42 and veins 64 themselves.

It has been anecdotally found that blood glucose levels are generally reduced in persons utilizing the BPM therapy method 300. It is believed herein that the above listed hypothesized mechanisms are responsible for this phenomenon. The enhancement of lymph circulation is of specific interest in this regard because it is hypothesized that it assists in disposing of incompletely metabolized sugar stored in the interstitial spaces 50. In any case, the reduction of blood glucose levels is quite beneficial for persons having diabetes, and has typically occurred in persons having either Type 2 diabetes or Type 2 diabetes with insulin. On the other hand, it can lead to a non-diabetic person achieving too low a sugar level. It has been found that if one is subject to this type of condition, he or she can usually avoid it by consuming a glass of fruit juice before and even after utilizing the BPM therapy method 300.

Approximately 70,000 diabetic persons suffer lower extremity amputations every year as a result of having supposedly irreversible neuropathy, extreme peripheral artery disease or incurable wounds (i.e., that turn gangrenous) as well as the above noted lower limb lymphedema with abnormal tissue swelling. In addition to reversing the lymphedema with abnormal tissue swelling in the manner described hereinabove, the BPM therapy method 300 has also been anecdotally found to reverse such supposedly irreversible neuropathy and extreme peripheral artery disease as well as achieve therapeutic closure of such supposedly incurable wounds. Again, it is believed herein that the above listed hypothesized mechanisms are responsible for this phenomenon. Specifically, it is hypothesized that these results are at least in part a result of increased blood flow and are yet other manifestations of the above-described manner in which the BPM therapy method 300 typically clears blockages in fluid flow channels.

It is not believed that BPM therapy has the capability of “regenerating” nerves. None-the-less, other case studies have served to anecdotally demonstrate reduction of nerve related disorders such as indicated by significantly reduced symptoms of persons having Parkinson's disease. In accordance with the latest theories relating to the cause of Parkinson's disease such as by toxic “clumping” destruction of substantia nigra (SN) neurons (i.e., as shown in “Aggregation of alpha-synuclein by DOPAL, the monoamine osidase metabolite of dopamine”, by William J. Burke et. al. and published on line in Acta Neuropathologica, copyright Springer-Verlag 2007), it is believed herein that the above described manipulation of related neural flow channels tends to break down the “clumping” action and thereby restore still surviving SN neurons to proper functionality. Consistent with that hypothesis, “early onset” Parkinson's subjects have had the greatest success with the BPM therapy method 300.

A reduction of medication dosages, or in some cases even their total elimination, has been a further benefit for many persons utilizing BPM therapy. By way of example, some persons having Type 2 diabetes with insulin have had to reduce or even eliminate their usage of insulin in order to avoid becoming hypoglycemic because of the above noted reduction of blood glucose. In another example, persons having Parkinson's disease have typically had to reduce their normally prescribed medication dosages in order to avoid overdose symptoms (i.e., such as uncontrolled and wildly gyrating arm and leg motions). It is hypothesized that many such reductions of medication dosages have come about because of increased blood circulation and/or elimination of the above described “clumping” action resulting from using BPM therapy. Therefore, an additional benefit of using BPM therapy in accordance with the BPM therapy method 300 may be that medication dosages can be reduced, or in some cases even eliminated.

Finally, it is believed that the phenomenon of drug addiction involves interaction with dopamine generated within the brain. Because of this as well as the calming influence of BPM therapy, it is hypothesized that utilization of BPM therapy may be helpful in rehabilitation treatment for various forms of drug addiction.

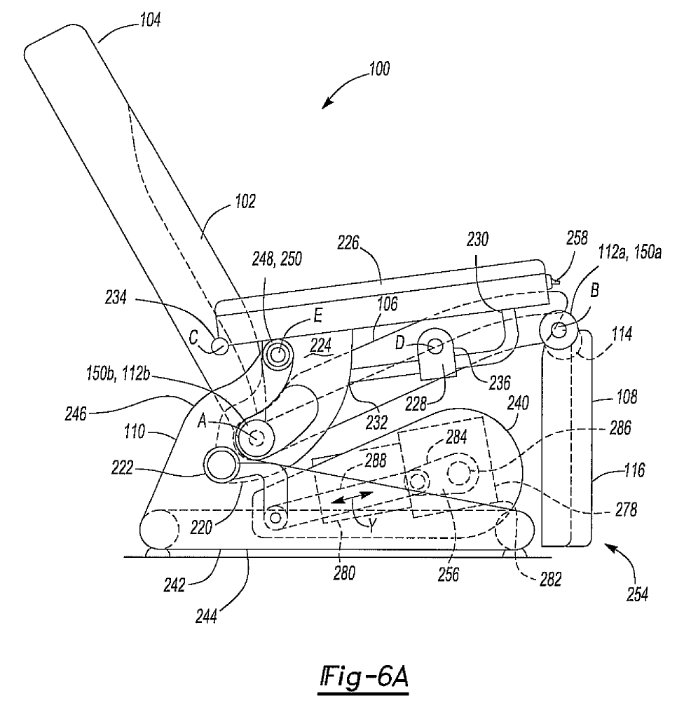

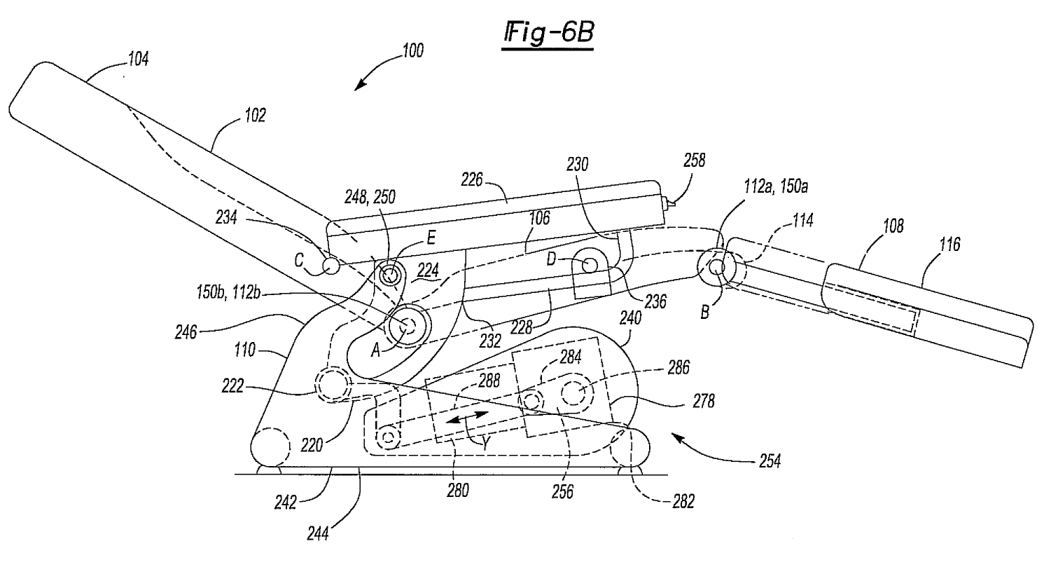

FIGS. 6A and 6B are respective upright and reclined position side views of a recliner chair 100 configured in accordance with the preferred embodiment of the present invention. The recliner chair 100 is herein presented as a specific implementation of the example generic Kinetic Recliner Chair 10 shown above in FIGS. 1A, 1B and 1C. In this example, the recliner chair 100 includes a reclining chair 102 comprising a torso and head-supporting portion 104, a thigh-supporting portion 106, and an ottoman portion 108 as well as a supporting trunion assembly 110. The torso and head-supporting portion 104 and thigh-supporting portion 106 are hingedly affixed one to another along transverse axis “A” while the thigh-supporting portion 106 and ottoman portion 108 are hingedly affixed one to another along transverse axis “B”.

When the reclining chair 102 is disposed in the upright position depicted in FIG. 6A, the torso and head-supporting portion 104 and the thigh-supporting portion 106 are displaced from one another by an internal obtuse angle of perhaps 96 degrees with the torso and head-supporting portion 104 angled backwards from a vertical direction by perhaps 30 degrees and the thigh-supporting portion 106 angled upwards from a horizontal direction by perhaps 24 degrees while the thigh-supporting portion 106 and ottoman portion 108 are displaced from one another by an external angle of perhaps 294 degrees with the ottoman portion 108 nominally hanging in a vertical direction.

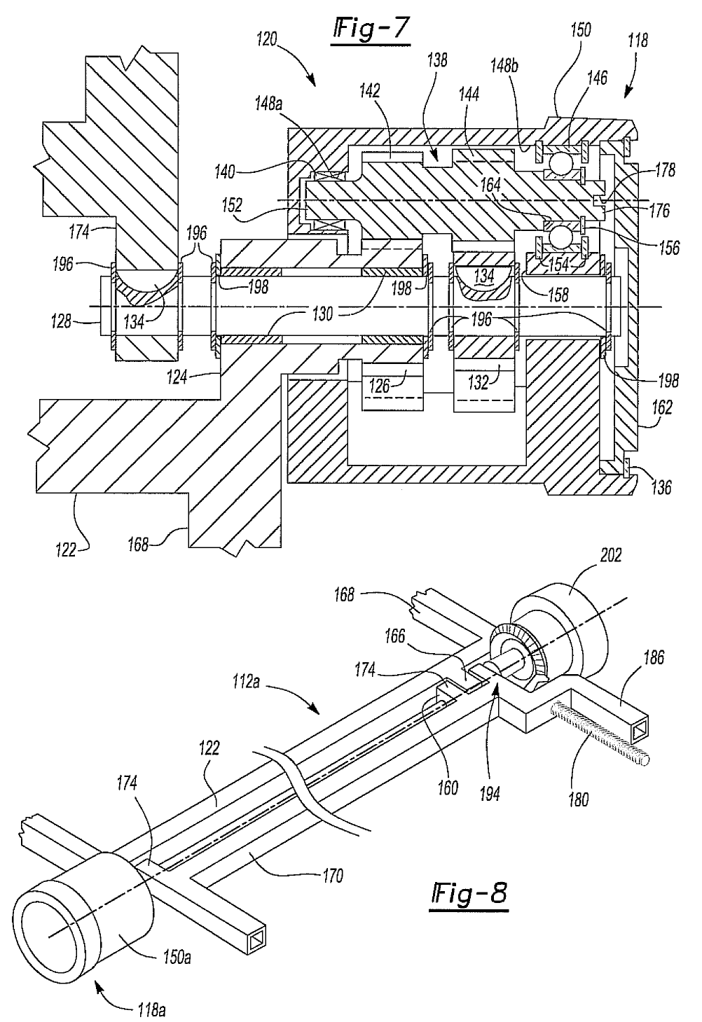

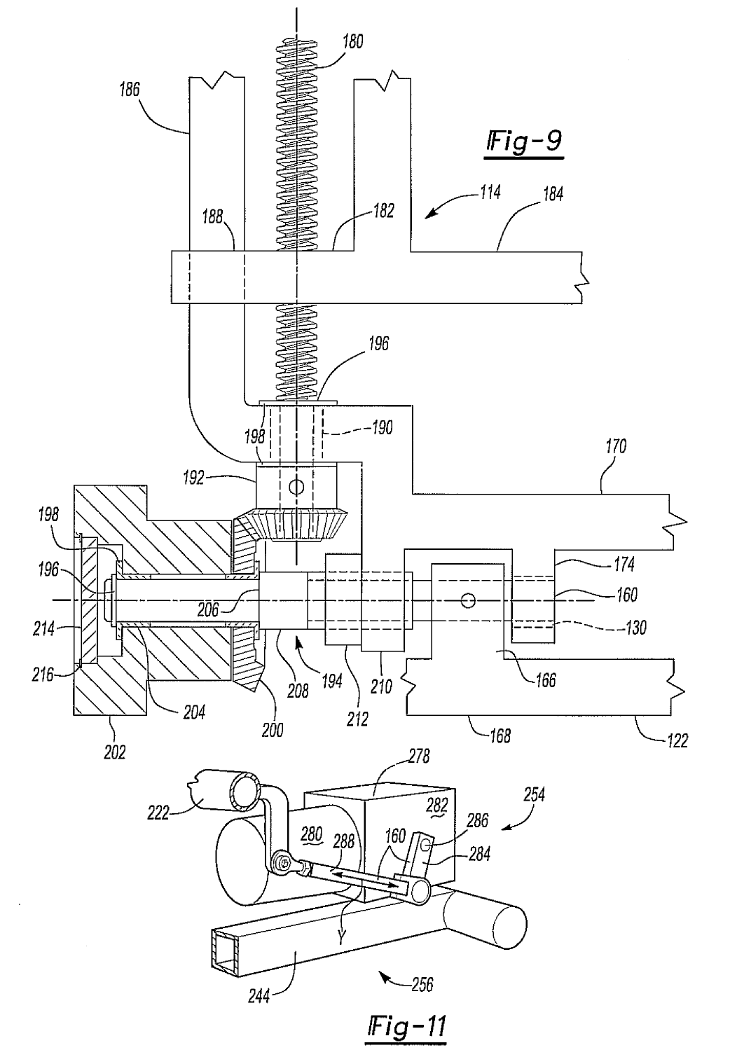

Prior to initiation of the intended cyclical rocking motion mode of operation, the reclining chair 102 is preferably moved to an initial reclined position as depicted in FIGS. 1A and 6B by sequentially manipulating respective ottoman elevating and extending mechanisms 112a and 114, and then a torso reclining mechanism 112b with the ottoman elevating and torso reclining mechanisms 112a and 112b being described below with reference to FIGS. 7 and 8, and the ottoman extending mechanism 114 being described below with reference to FIG. 9. When the reclining chair 102 is disposed in its initial reclined position, the torso and head-supporting portion 104 is preferably angled upwards (e.g., from the transverse axis “A” with reference to the horizontal direction) by an angle approximately equal to the selected angular range, the thigh-supporting portion 106 is preferably oppositely angled upwards by angle approximately equal to half of the selected angular range, and the ottoman portion 108 is preferably angled downwards (e.g., from the transverse axis “B” with reference to the horizontal direction) by an angle approximately equal to half of the selected angular range with an ottoman 116 thereof then extended as desired (e.g., from the transverse axis “B”). Thus in the event that the selected angular range has the preferred value of 30 degrees, the torso and head-supporting portion 104 is preferably angled upwards by 30 degrees, the thigh-supporting portion 106 is preferably angled upwards by 15 degrees, and the ottoman portion 108 is preferably angled downwards by 15 degrees with the ottoman 116 extended as desired whenever the reclining chair 102 is in its initial reclined position. Thus, the obtuse angle between the torso and head-supporting portion 104 and the thigh-supporting portion 106 is increased by 39 degrees to 135 degrees, and the external angle between the thigh-supporting portion 106 and the ottoman portion 108 is decreased by 84 degrees to 210 degrees. It has been found that an adequate mechanical advantage for accomplishing either task can be obtained when respective selected gear ratios for the ottoman elevating and torso reclining mechanisms 112a and 112b result in achieving these rotational values over a range of motion of about three turns of their respective control knobs 150a and 150b.

FIG. 7 depicts a generic hand operated rotational assembly 118 comprising an external differential planetary gear set 120 such as utilized herein in the ottoman elevating and torso reclining mechanisms 112a and 112b. External differential planetary gear sets such as the hand operated rotational assembly 118 are non-reversible. This is because their meshing gear interfaces differentially carry full load torque. This renders them with a negative reverse efficiency value whereby they are in fact non-reversible.

A first hand operated rotational assembly 118a is utilized in the ottoman elevating mechanism 112a for angularly elevating the ottoman 116 by the above derived 84 degrees while a second hand operated rotational assembly 118b is utilized in the torso reclining mechanism 112b for angularly repositioning the torso and head-supporting portion 104 and the thigh-supporting portion 106 with respect to one another by the also above derived 39 degrees. They are mounted in the following manner at respective interfaces between the thigh-supporting portion 106 and the ottoman portion 108; and between the torso and head-supporting portion 104 and the thigh-supporting portion 106.

At either of the interfaces between the torso and head-supporting portion 104 and the thigh-supporting portion 106, and between the thigh-supporting portion 106 and the ottoman portion 108, a structural frame 168 of the thigh-supporting portion 106 includes a transverse member 122 having a bracket 124 comprising a first sun gear 126. A shaft 128 is rotatively inserted through bushings 130 mounted within the bracket 124, and is axially located with reference to the bracket 124 by a pair of washers 198 and retaining rings 196. A second sun gear 132 is rotationally and axially retained on the shaft 128 via utilization of a key 134 and a pair of retaining rings 196. Shafts 128 are fixedly mounted to the ottoman portion 108, and the torso and head-supporting portion 104 during assembly of the reclining chair 102. In an example method for accomplishing this herein illustrated in FIG. 7, a key 134 and pair of retaining rings 196 are used to secure the shaft 128 to a first bracket 174 comprised in a structural support frame 170 of the ottoman portion 108.

Three differential planetary gear assemblies 138 surround and are constantly in mesh with the first and second sun gears 126 and 128. Each of the three differential planetary gear assemblies 138 comprises a needle bearing 140, a first planetary gear 142, a second planetary gear 144 and a ball bearing 146. The first and second planetary gears 142 and 144 are formed from a single shaft 152 with one of each of their grooves (e.g., between two of their teeth) being in line the other. For ease of assembly, a face groove 176 and a screwdriver slot 178 formed in the end of the shaft 152 identify the rotational position of those in line grooves.

In assembling either of the hand operated rotational assemblies 118a and 118b, needle bearings 140 are first pressed into each of three first bearing mounting bores 148a formed in a knob 150. Then the knob 150 is slidingly positioned over the first and second sun gears 126 and 132 to a position where contact is made between a shoulder 158 formed in the knob 150 and a washer 198 butting against the retaining ring 196 that retains the second sun gear 132. The knob 150 is retained axially with respect to the shaft 128 via another washer 198 and a retaining ring 196. Then the shafts 152 are sequentially inserted with their first and second planetary gears 142 and 144 engaging the first and second sun gears 126 and 132 and their far ends supported by the needle bearings 140. This is followed by insertion of a retaining ring 154 and a ball bearing 146 within each of three corresponding bearing mounting bores 148b. Then another retaining ring 154 is used to retain each ball bearing 146, and a retaining ring 156 is used to position a shoulder 164 formed on the shafts 152 against each ball bearing 146. Thus, each of the three differential planetary gear assemblies 138 is positioned in mesh with the first and second sun gears 126 and 132, and retained appropriately within the knob 150. Finally, an end plate 162 is retained within the end of the knob 150 by still another retaining ring 136.

As further described below, the above described concomitant mounting of the three differential planetary gear assemblies 138 is possible as a consequence of utilizing selected gear tooth number combinations and angularly spacing the bearing mounting bores 148a and 148b for each of the first and second hand operated rotational assemblies 118a and 118b. In either case, concentric running of the knob 150 is maintained without bushing or bearing support via meshing of the three differential planetary gear assemblies 138 with the first and second sun gears 126 and 132.

A generally known method for calculating the overall gear ratio between a planetary carrier and an output sun gear of an external differential planetary gear set is to figuratively rotate the whole set by one turn, rotate the fixed one of the sun gears back to its original stationary position while holding the planetary carrier fixed, subtract the resulting motion of the output sun gear from the one turn, and finally, invert that number to find the overall ratio. Thus the following numbers of teeth (e.g., with each element of the first hand operated rotational assembly 118a identified by its numerical indicator plus an “a” suffix) are chosen for the gears 126a, 132a, 142a and 144a of the first hand operated rotational assembly 118a:

N₁₂₆ₐ=19 teeth,

N₁₃₂ₐ=19 teeth,

N₁₄₂ₐ=14 teeth, and

N₁₄₄ₐ=15 teeth,

whereby the overall gear ratio between the planetary carrier or knob 150a and the output sun gear or second sun gear 132a and shaft 128a (e.g., with reference to the first sun gear 126a) is

R₁₈₁ₐ=1/[1−(N₁₂₆ₐ/N₁₄₂ₐ)(N₁₄₄ₐ/N₁₃₂ₐ)]=1/[1−(19/14)(15/19)]=−14:1,

where −14:1 is the ratio between the angle of rotation of the knob 150a and the elevating angle. The fact that the ratio has a negative value means that the ottoman 116 will be elevated when the knob 150a is rotated in a forward, or as depicted in FIG. 7, a clockwise direction. This means that the knob 150a would need to be rotated in a clockwise direction by (14)(84/360)=3.27 turns in order to fully elevate the ottoman as described above.

In this case, a known method of utilizing identical 25 degree gear cutting apparatus for cutting the teeth on both the (15+19)=34 tooth and the (14+19)=33 tooth meshing pairs with proportionately larger diametral pitch values on the (14+19)=33 tooth meshing pair can be used as follows: If the teeth on the (15+19)=34 tooth meshing pair are cut in the normal manner with a module 1.25×25 degree pressure angle cutter, then the pitch diameters of the second sun gear 132a and second planetary gear 144a will in fact be 23.75 mm and 18.75 mm, respectively. But then the pitch diameter of the first sun gear 126a will have to be 19[(15+19)/(14+19)] or 24.4697 mm, and the pitch diameter of the first planetary gear 142a will be 17.50−[(15+19)/(14+19)] or 18.0303 mm; with their base circle diameters being 23.75 cosine (25 degrees)=21.5248 mm and 17.50 cosine (25 degrees)=15.8604 mm, respectively. As a result, the effective pressure angle of both the first sun gear 126a and the first planetary gear 142a will be cosine⁻¹ (21.5248/24.4697)=cosine⁻¹ (15.8604/18.0303) or 28.40 degrees.

It is a simple matter to get all 19 of the teeth in both of the first and second sun gears 126a and 132a to line up because both of them have 19 teeth. Thus, if the three sets of bearing mounting bores 148a and 148b formed in the knob 150a are located with angular spacings of (6/19)360=113.684 degrees between them (e.g., along with a remaining spacing of (7/19)360=132.632 degrees) then the knob 150a can be positioned with a tooth of the second sun gear 132a centered with reference to each bearing bore 148b, and all of the three differential planetary gear assemblies 138a can be inserted concomitantly via positioning each of them with its face groove 176 facing radially inwards.

On the other hand (e.g., with each element of the second hand operated rotational assembly 118b identified by its numerical indicator plus a “b” suffix), a different selection of gears is required in the second hand operated rotational assembly 118b used for the torso reclining mechanism 112b because an increased overall gear ratio between its knob 150b and second sun gear 132b is required in order to achieve a desired range of motion of about three turns. At the same time, it is desired to maintain a similarly straightforward assembly procedure. Thus, the following numbers of teeth are chosen for each gear of the second hand operated rotational assembly 118b:

N_{126b}=30 teeth,

N_{132b}=27 teeth,

N_{142b}=15 teeth, and

N_{144b}=14 teeth.

This results in the overall gear ratio between the knob 150b and the shaft 128b (e.g., with reference to the first sun gear 126b) being

R_{118b}=1/[1−(N_{126b}/N_{142b})(N_{144b}/N_{132b})]=1/[1−(30/15)(14/27)]=−27:1

where −27:1 is the ratio between the angle of rotation of the knob 150b and the reclining angle.

This time however, the tooth count difference (e.g., 45 teeth vs. 41 teeth) between the meshing pairs is too great to accommodate utilization of the same 1.25 module 25 degree gear cutting apparatus for both meshing pairs. Thus, special 1.372 module 25 degree gear cutting apparatus is used for cutting the (14+27)=41 tooth meshing pair. In any case, the fact that the ratio R_{118b} has a negative value means that the torso reclining mechanism 112b will be moved toward its reclined position when the knob 150b is rotated in a forward, or clockwise direction. This means that the knob 150b would need to be rotated in a clockwise direction by (27)(39/360)=2.925 turns in order to move the torso and head-supporting portion 104 into its fully reclined position as described above.

It is a simple matter to get every 9^{th} tooth of the second sun gear 132b to line up with every 10^{th} tooth in the first sun gear 126b because the second sun gear 132b has 27 teeth and the first sun gear 126b has 30 teeth. Thus, if the three sets of bearing mounting bores 148a and 148b are formed at (9/27)360=(10/30)360=120 degrees with respect to one another, then the knob 150b can be positioned with the respective 9^{th} and 10^{th} aligned teeth of the first and second sun gears 126b and 132b centered with reference to each bearing bore 148b, and all three differential planetary gear assemblies 138b can again be inserted concomitantly via positioning each of them with its face groove 176 facing radially inwards.

FIG. 8 is perspective view of the complete ottoman elevating mechanism 112a wherein both the transverse member 122 of the structural frame 168, and the structural support frame 170 can be seen to extend from the hand operated rotational assembly 118a across the interface between the thigh-supporting portion 106 and the ottoman portion 108 to brackets 166 and 174 whereat a shaft 160 rotatively supports the opposite side of the structural support frame 170 in a hinge-like manner. The torso reclining mechanism is similarly configured but in a mirror-imaged manner across the interface between the thigh-supporting portion 106 and torso and head-supporting portion 104.

FIG. 9 is a sectioned plan view of the ottoman extending mechanism 114. The ottoman extending mechanism 114 is activated by a multi-start leadscrew 180 driving a mating nut 182 attached to a structural frame 184 of the ottoman 116. The structural frame 184 is guided axially along extending members 186 of the structural support frame 170 of the ottoman portion 108 by a downward facing channel 188 portion of the nut 182 as well as other similar downward facing channels (not shown). The multi-start leadscrew 180 is supported by a bushing 190 and rotationally driven by a smaller bevel gear 192 of a speed increasing bevel gear set 194. The multi-start leadscrew 180 is constrained axially via a retaining ring 196 and washers 198 positioned between either end of the bushing 190, and the bevel gear 192 and retaining ring 196.

The smaller bevel gear 192 is driven by a larger bevel gear 200 of the speed increasing bevel gear set 194. The larger bevel gear 200 is formed on a knob 202 that is mounted on another bushing 204. The bushing 204 is positioned against a shoulder 206 of a shaft 208 and retained there by another retaining ring 196 and pair of washers 198. The shaft 208 is adjustably attached to the structural support frame 170 of the ottoman portion 108 via threaded engagement with a bracket 210 thereof, and fixedly retained in position there by a jam nut 212. Finally, an end plate 214 is retained within the end of the knob 202 by a retaining ring 216 to complete the ottoman extending mechanism 114.

The supporting structure for the torso and head-supporting portion 104 and the thigh-supporting portion 106 of the reclining chair 102 is generally configured in a known manner first conceived and implemented commercially in the early 1970's by a Norwegian company named Ekornes ASA. As depicted in side view drawings shown in FIGS. 6A and 6B, the example reclining chair 102 comprises a sub-frame 220. The sub-frame 220 comprises a cross member 222 that fixedly supports left and right side vertical members 224. The left and right side vertical members 224 fixedly support left and right arm rests 226. Finally, left and right tubular members 228 fixedly couple points 230 on the front ends of the left and right arm rests 226 to points 232 on the front edges of the left and right side vertical members 224.

The torso and head-supporting portion 104 and the thigh-supporting portion 106 of the reclining chair 102 are respectively rotatably affixed to the left and right sides of the sub-frame 220 at left and right side pivot points 234 that are respectively located at the rearmost portion of the left and right arm rests 226, and left and right side pivoting and sliding bushings 236 that are respectively slidingly located along the left and right tubular members 228. Chair locating transverse axes “C” and “D” are respectively defined by transverse lines through the left and right side pivot points 234, and the left and right side pivoting and sliding bushings 236. Thus the torso and head-supporting portion 104 of the reclining chair 102 is pivotally coupled to the rear end of the left and right arm rests 226 about the transverse axis “C” via left and right side pivot points 234 and the thigh-supporting portion 106 is slidingly and pivotally coupled to left and right angled tubular members 228 about the transverse axis “D” via the left and right side pivoting and sliding bushings 236.

As shown in FIGS. 6A and 6B, the trunion assembly 110 rotatably supports the sub-frame 220. The trunion assembly 110 comprises a trunion yoke 242 having a supporting trunion base 244 and left and right trunion plates 246. The sub-frame 220 is rotatably mounted within the trunion assembly 240 by trunion pins 248 that are fixedly mounted in the left and right trunion plates 246 and engage the left and right side vertical members 224 of the sub-frame 220 via maintenance-free spherical bushings 250 positioned along a pivot axis “E”. Suitable maintenance-free spherical bushings for this purpose are manufactured by IKO under the type designation GE . . . EC. The type GE . . . EC maintenance-free spherical bushings comprise a spherical steel sliding member sliding within a female PTFE liner reinforced with a copper mesh.

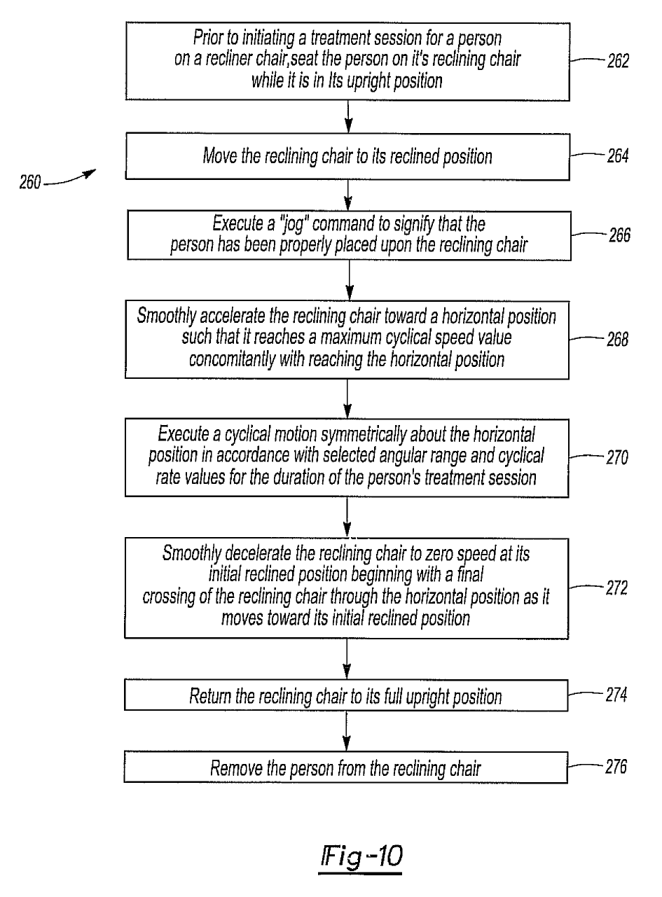

Finally, a drive mechanism 254 is utilized for rotatably moving the sub-frame 220, and therefore the reclining chair 102, in a cyclical manner about the pivot axis “E” in accordance with the selected angular range and cyclical rate values between the extreme positions depicted in FIGS. 1A and 1C. The incorporated '033 patent depicts a Scotch yoke drive assembly 96, a crank and connecting rod mechanism 188, a servo controlled rack and pinion gear set 194, and a servo controlled hydraulic drive 196, any of which would be suitable for cyclically moving the sub-frame 220, and therefore the reclining chair 102 of the recliner chair 100 of the present invention. Because descriptive presentations of the Scotch yoke drive assembly 96, the servo controlled rack and pinion gear set 194, and the servo controlled hydraulic drive 196 have been made in the incorporated '033 patent, no further description relating to any of these types of drive mechanisms is required herein. On the other hand, the preferred recliner chair 100 of the present invention utilizes a simplified example crank and connecting rod mechanism 256 that is depicted herein in FIG. 11 and described in detail hereinbelow.

Either of the Scotch yoke drive assembly 96 shown in FIGS. 8A-C of the incorporated '033 patent, crank and connecting rod mechanism 188 shown in FIGS. 9 and 11 of the incorporated '033 patent, or an example crank and connecting rod mechanism 256 utilized in the present invention can be controlled by a simple switch such as single throw switch 258 depicted in FIGS. 1A, 1B, 1C, 6A and 6B of the present application. In the case of the incorporated '033 patent such a switch would be operative to activate and deactivate a gearmotor 98 depicted in each of FIGS. 8A-C, 9 and 11 thereof.

On the other hand, either of the servo controlled rack and pinion gear set 194, or the servo controlled hydraulic drive 196 (i.e., comprising a servomotor driven pump and a hydraulic cylinder), respectively shown in FIGS. 12 and 13 of the incorporated '033 patent, could be utilized for achieving individually selected combinations of angular motion and cyclical rate as deemed suitable for individual persons. In either case, a controller 130 also shown and described in the incorporated '033 patent could be used for commanding appropriately selected angular range and cyclical rate values, or even for programming varying values of angular ranges and cyclical rates during treatment sessions.

FIG. 10 of the present application illustrates an example method 260 for optimally controlling a recliner chair 100 driven by either of the servo controlled rack and pinion gear set 194, or the servo controlled hydraulic drive 196 of the incorporated '033 patent. Such optimal control can be obtained through programming controller 130 of the incorporated '033 patent for operation over a BPM therapy session for a person 12 including individually selected angular range and cyclical rate values in accordance with the following steps:

A first step 262 of the example method 260 is executed prior to initiating the BPM therapy session for a person 12 on a recliner chair 100 and includes the seating the person 12 on the reclining chair 102 while it is in its upright position as shown in FIG. 6A. A second step 264 includes the moving the reclining chair 102 to its reclined position via sequential manipulation of ottoman elevating mechanism 112a, the ottoman extending mechanism 114, and the torso reclining mechanism 112b described above. A third step 266 includes executing a “jog” command signifying that the person 12 has been properly placed on the reclining chair 102, and enabling the program to continue. A fourth step 268 includes smoothly accelerating the reclining chair 102 toward its central or nominally horizontal position such that it reaches a maximum cyclical speed value concomitantly with reaching the horizontal position. A fifth step 270 includes executing a cyclical motion symmetrically about the horizontal position in accordance with the selected angular range and cyclical rate values for the duration of the BPM therapy session.

Implementing the fifth step 270 with a sinusoidal velocity profile can easily be accomplished via suitably programming the controller 130. Other velocity profiles are certainly possible however and can easily be accommodated by programming the controller 130 with a velocity profile having both sinusoidal and appropriate harmonics. Given these descriptions, one of ordinary skill in the art will recognize several variations in providing suitable velocity profiles for cyclically moving the reclining chair 102.

In any case, stopping the reclining chair 102 in accordance with a sixth step 272 of the BPM therapy method 300 includes smoothly decelerating the reclining chair 102 to zero speed at its initial reclined position, beginning with a final crossing of the reclining chair 102 through the horizontal position as it moves toward its initial reclined position. Given this description, one of ordinary skill in the art will recognize and be able to generate command sequences for obtaining suitable combinations of acceleration/deceleration characteristics, other treatment angular range and cyclical rate values, or varying values of angular ranges and cyclical rates during treatment sessions in order to meet the needs of particular persons. Finally, a seventh step 274 includes returning the reclining chair 102 to its original upright position and an eighth step 276 includes removing the person 12 from the recliner chair 100.

Shown in FIG. 11 is a perspective view of the drive mechanism 254 with a crank and connecting rod cover 240 shown in FIGS. 6A and 6B removed. In this example, the drive mechanism 254 includes a gearmotor 278 comprising a motor 280 and a speed-reducing gearbox 282 mounted upon the trunion base 244. The afore-mentioned example crank and connecting rod drive mechanism 256 includes a crank 284 that is driven via an output shaft 286 of the speed-reducing gearbox 282. The crank 284 engages a connecting rod 288 that is pivotally connected to the cross member 222 of the sub-frame 220.

In this case the single throw switch 258 is operative to activate and deactivate the motor 280 and thus the drive mechanism 254. It is true that the drive mechanism 254 is capable of only providing a single valued angular range. However, it does have the advantage of including readily available components such as the gearmotor 278 and single throw switch 258. Therefore, it follows that a recliner chair 100 comprising the example drive mechanism 254 can be quickly and economically developed, and may in fact, be more economical to produce. This could be important because it would be desirable to produce recliner chairs 100 in large volumes for home use by persons having various types of physical and neural diseases or conditions such as Parkinson's disease, Alzheimer's disease, essential tremor, muscular dystrophy, autism, migraine headaches, traumatic brain injuries, varicose veins, fibromyalgia, drug addiction, and diabetes related problems such as high glucose count, impaired circulation, neuropathy, open wounds, and lymphedema with abnormal tissue swelling.

Surprisingly, there is also an advantage in not utilizing a controller such as the controller 130 shown and described in the incorporated '033 patent. This is because such controllers typically utilize a bridge circuit comprising solid state switching devices that are usually relatively unshielded and therefore a source of high frequency electromagnetic radiation that is considered to be undesirable by a significant percentage of potential users of the recliner chair 100. In fact, such high frequency electromagnetic radiation could conceivably be dangerous for individuals using pacemakers. Thus, utilization of the drive mechanism 254 as controlled by the simple single throw switch 258 in recliner chair 100 is considered herein to be preferable.

In the example drive mechanism 254 the gearmotor 278 serves to rotate the crank 284. Rotation of the crank 284 cyclically moves the connecting rod 288 back and forth along an undulating thrust axis “Y” and moves the sub-frame 220 and thus the reclining chair 102 about the pivot axis “E”. The resulting cyclical motion of the reclining chair 102 alternately elevates the upper torso and head, and then the lower extremities of a person lying on the reclining chair 102 in the cyclical manner described hereinbefore.

As can be appreciated, the length of the crank 284 can be designed for a larger or smaller angular motion of the sub-frame 220 and resulting angular range values for the reclining chair 102, or even be configured in the manner of adjustable length crank arm 40 of the incorporated '033 patent in order to attain selected angular range values. Given these descriptions, one of ordinary skill in the art will recognize several variations in providing suitable drive mechanisms for cyclically moving the reclining chair 102.

Finally, FIG. 12 is a flow chart that illustrates the example method 300 for implementing a BPM therapy session for a person 12. Again, the BPM therapy method 300 has been anecdotally observed to be therapeutically helpful for enabling an improved quality of life for persons having various types of physical and neural diseases or conditions such as Parkinson's disease, Alzheimer's disease, essential tremor, muscular dystrophy, autism, migraine headaches, traumatic brain injuries, varicose veins, fibromyalgia, drug addiction, and diabetes related problems such as high glucose count, impaired circulation, neuropathy, open wounds, and lymphedema with abnormal tissue swelling.

A first step 302 of the BPM therapy method 300 includes providing a recliner chair 100 having a reclining chair 102 for enabling both upright and reclined positions, where the reclining chair 102 is configured such that when disposed in its reclined position it retains the person 12 thereupon in a generally supine position along a downward tilted longitudinal axis such that his or her upper torso and head are longitudinally spaced apart from and vertically positioned above his or her lower extremities, and further where the recliner chair 100 also comprises a supporting structure as well as a gearmotor and drive mechanism for pivotally supporting and moving the reclining chair 102 in a cyclical manner wherein the downward tilted longitudinal axis is moved through a nominally horizontal orientation to an upward tilted orientation and vice versa.

A second step 304 includes seating the person 12 on the reclining chair 102 while it is in an upright position.

A third step 306 includes moving the reclining chair 102 into its fully reclined position including elevating and longitudinally positioning an ottoman thereof such that the person 12's lower extremities are appropriately elevated so that the person 12 lies supinely thereupon with his or her upper torso and head, and lower extremities spaced apart generally along the downward tilted longitudinal axis.

A fourth step 308 includes activating the gearmotor for the purpose of cyclically moving or tilting the recliner chair 100, and of course the person 12, from the initial upper torso and head-elevated position through a nominally centered horizontal position (hereinafter “horizontal position”) to a lower extremities-elevated position and the reverse in a cyclical “seesaw” manner in order to implement the BPM therapy method 300.

This results in a cyclical elevation of the person 12's upper torso and head above his or her lower extremities, and then his or her lower extremities above his or her upper torso and head, and vice-versa. As described above, the cyclical rate of alternate elevation of the person 12's upper torso and head, and lower extremities (hereinafter “cyclical rate”) is preferably about 6 cycles/minute while the total angular range of motion (hereinafter “angular range”) of the support member relative to its nominally centered horizontal position is preferably around 30°.

A fifth step 310 of the BPM therapy method 300 includes establishing and maintaining a comfortable and relaxed state of the person 12.

In a preferred example, such a comfortable and relaxed state corresponds to establishing a sleep state of the person while he or she is experiencing the BPM therapy method 300. In another example, the comfortable and relaxed state corresponds to a relatively low blood pressure state of the person, such as at or even below an “at rest” blood pressure determined according the person's age, weight, height, or other factors. In yet another example, the comfortable and relaxed state corresponds to the heart rate of the person, such as an “at rest” heart rate determined according the person's age, weight, height, or other factors. Factors involved in establishing and maintaining the comfortable and relaxed state of the person include: locating the recliner chair 100 in a relatively isolated and quite environment; avoiding any contact with the person (i.e., such as talking to him or her) during his or her treatment period with the purpose of inducing him or her to fall into a sleep state; and/or failing that, engaging in quiet and relaxing conversation with the person for the purpose of calming him or her if he or she exhibits hyperactivity, hypersensitivity or hyperirritability symptoms.

A sixth step 312 includes stopping the reclining chair 102 in its initial downward tilted fully reclined position.

A seventh step 314 includes returning the reclining chair 102 to its original upright position.

And finally, an eighth step 316 includes removing the person from the reclining chair 102 in order to terminate the BPM therapy session.

Prior to beginning any treatment using the present invention, a preliminary workup comprising noting a person's vital statistics and perhaps performing any pertinent neurological testing could be done in order to establish a baseline status for that person as of the start of that particular treatment session. One might note the person's age, blood pressure, heart or neurological disease history. Should that person be diabetic one might also record blood count, neuropathy or other appropriate tests. In addition, special precautions or procedures should be taken in the case of a brain injured person or perhaps for one confined to a wheelchair or one having Alzheimer's disease. Further, it would be desirable to do a comparative post treatment workup as well in order to record any changes related to the person having experienced the BPM therapy method 300 during that session. And still further, it would be desirable to compile each person's workup documentation in order to establish that person's progress over time.

Although preferred embodiments of this invention have been disclosed, workers of ordinary skill in the various arts associated with this invention would recognize that certain modifications would come within the scope of this invention. For instance, BPM therapy could be utilized for treating diseases or conditions not named above. Also, the construction details of the recliner chair 100 could be altered without deviating from the spirit of this invention. By way of example, the first and second hand operated assemblies 118a and 118b could be replaced by motor and leadscrew actuated assemblies in the ottoman elevating and torso reclining mechanisms, and/or the speed-reducing gearbox 282 could be replaced by the combination of a hydraulic pump and hydraulic motor whose output shaft would then be utilized for driving the crank 284. For that reason, the following claims should be studied to determine the true scope and content of this invention.

What is claimed is:

1. A method for therapeutic treatment of a disease or ailment condition through the use of venous blood pressure modulation (BPM) therapy, said method comprising the steps of:
providing a recliner chair BPM apparatus comprising:
a reclining chair member configured to selectively retain a person thereupon in a supine manner generally along a longitudinal axis such that said person's upper torso and head are longitudinally spaced apart from said person's lower extremities;
said recliner chair BPM apparatus further including a trunion assembly for pivotingly supporting said reclining chair member about a transversely disposed pivot axis nominally orthogonal to a vertical plane comprising said longitudinal axis, said longitudinal axis of said reclining chair member then being operative for defining instant rotational orientations of said reclining chair member around said pivot axis;
said recliner chair BPM apparatus further including a motor; and
a drive mechanism for selectively coupling said motor to said reclining chair member;
wherein said motor is energizable for rotatably and cyclically moving said reclining chair member about said pivot axis;
disposing a person on said reclining chair member so that said person lies supinely thereupon with his or her upper torso and head, and lower extremities spaced apart generally along said longitudinal axis; and
energizing said motor so as to activate said recliner chair BPM apparatus and thereby rotatably move said reclining chair member about said pivot axis through many cycles wherein said person's lower extremities are raised to a level higher than said person's upper torso and head, and vice-versa during each cycle;
wherein each cycle causes a modulation of the person's venous blood pressure wherein resulting multiple venous blood pressure modulation and/or switching events cause compression and stretching of the veins of the person's upper torso and head, and concomitantly, swelling and shrinking of the veins of the person's lower extremities, and
wherein said multiple venous blood pressure modulation and/or switching events result in cumulative internal massaging of arteries and fine arteries, neural fluid flow channels, and lymph fluid flow channels in the person's upper torso and head, and/or lower extremities.

2. The method as set forth in claim 1, wherein said reclining chair member comprises:
a torso and head-supporting portion;
a thigh-supporting portion; and
a lower extremity-supporting portion comprising an ottoman
wherein the torso and head-supporting portion is attached to the thigh-supporting portion in an angularly variable manner, the lower extremity-supporting portion is similarly attached to the thigh-supporting portion in an angularly variable manner, and the ottoman is longitudinally positionable within the thigh-supporting portion.

3. The method as set forth in claim 2, wherein said reclining chair member further comprises:
a first non-reversible angular adjustment apparatus for varying the angular relationship between said torso and head-supporting and said thigh-supporting portions; and
as second non-reversible angular adjustment apparatus for varying the angular relationship between said thigh-supporting and said attached lower extremity portions.

4. The method as set forth in claim 3, wherein either of said non-reversible angular adjustment apparatus comprises a hand operated external differential planetary gear set.

5. The method as set forth in claim 2, wherein said reclining chair member further comprises longitudinal positioning apparatus for positioning said ottoman within said thigh-supporting portion.

6. The method as set forth in claim 5, wherein said longitudinal positioning apparatus comprises a multi-start leadscrew and mating nut.

7. The method as set forth in claim 2, wherein said reclining chair member is configured such that when it is disposed in an upright position, its torso and head-supporting portion is angled backwards with reference to the vertical direction, its thigh-supporting portion is oppositely angled upwards with reference to the horizontal direction, and its lower extremity or ottoman portion is angled downwards in a nominally vertical direction.

8. The method as set forth in claim 2, wherein said reclining chair member is configured such that when it is disposed in an initial reclined position, its torso and head-supporting portion is angled upwards with reference to the horizontal direction by an angle approximately equal to the selected angular range, its thigh-supporting portion is oppositely angled upwards with reference to the horizontal direction by an angle approximately equal to half of the selected angular range, and its lower extremity or ottoman portion is angled downwards with reference to the horizontal direction by an angle approximately equal to half of the selected angular range with said ottoman disposed in an extended position as desired.

9. The method as set forth in claim 1, wherein the angular range of motion of said longitudinal axis of said reclining chair member, and said person, extends between 10° and 60° in a downward pitch angle direction from said initial reclined position about said pivot axis.

10. The method as set forth in claim 1, wherein said longitudinal axis of said reclining chair member, and said person, extends about 30° in a downward pitch angle direction from said initial reclined position about said pivot axis.

11. The method as set forth in claim 1, wherein the cyclical rate utilized for rotatably and cyclically moving said longitudinal axis of said reclining chair member, and said person, about said pivot axis is between 2 cycles/minute and 10 cycles/minute.

12. The method as set forth in claim 1, wherein the cyclical rate utilized for rotatably and cyclically moving said longitudinal axis of said reclining chair member, and said person, about said pivot axis is about 6 cycles/minute.

13. The method as set forth in claim 1, wherein the product of the angular range of motion of said longitudinal axis of said reclining chair member and the cyclical rate utilized for rotatably and cyclically moving said longitudinal axis of said reclining chair member is between 90 degree-cycles/minute and 270 degree-cycles/minute.

14. The method as set forth in claim 1, wherein the product of the angular range of motion of said longitudinal axis of said reclining chair member and the cyclical rate utilized for rotatably and cyclically moving said longitudinal axis of said reclining chair member is about 180 degree-cycles/minute.

15. The method as set forth in claim 1, wherein said drive mechanism is selected from the group comprising a Scotch yoke mechanism, a crank and connecting rod mechanism, a linear drive mechanism, and a hydraulic drive mechanism.

16. The method as set forth in claim 1, wherein said drive mechanism is a crank and connecting rod mechanism.

17. The method as set forth in claim 1, wherein the disease or ailment condition is from among the group comprising Parkinson's disease, Alzheimer's disease, essential tremor, muscular dystrophy, autism, migraine headaches, traumatic brain injuries, varicose veins, fibromyalgia, drug addiction, and diabetes related problems such as high glucose count, impaired circulation, neuropathy, open wounds, and lymphedema with abnormal tissue swelling.

18. The method as set forth in claim 1, wherein the disease or ailment condition is heart disease, or other forms of cardiovascular disease.

19. The method as set forth in claim 1, wherein the disease or ailment condition is peripheral artery disease.

20. The method as set forth in claim 1, wherein the disease or ailment condition is Parkinson's disease.

21. The method as set forth in claim 1, wherein the disease or ailment condition is Alzheimer's disease.

22. The method as set forth in claim 1, wherein the disease or ailment condition is essential tremor.

23. The method as set forth in claim 1, wherein the disease or ailment condition is muscular dystrophy.

24. The method as set forth in claim 1, wherein the disease or ailment condition is autism.

25. The method as set forth in claim 1, wherein the disease or ailment condition is migraine headaches.

26. The method as set forth in claim 1, wherein the disease or ailment condition is traumatic brain injuries.

27. The method as set forth in claim 1, wherein the disease or ailment condition is varicose veins.

28. The method as set forth in claim 1, wherein the disease or ailment condition is fibromyalgia.

29. The method as set forth in claim 1, wherein the disease or ailment condition is drug addiction.

30. The method as set forth in claim 1, wherein the disease or ailment condition is from among the diabetes related group comprising high glucose count, impaired circulation, neuropathy, open wounds, and lymphedema with abnormal tissue swelling.

31. The method as set forth in claim 1, wherein the disease or ailment condition is high glucose count.

32. The method as set forth in claim 1, wherein the disease or ailment condition is impaired circulation.

33. The method as set forth in claim 1, wherein the disease or ailment condition is neuropathy.

34. The method as set forth in claim 1, wherein the disease or ailment condition is open wounds.

35. The method as set forth in claim 1, wherein the disease or ailment condition is lymphedema with abnormal tissue swelling.

36. The method as set forth in claim 1, wherein the method additionally comprises the steps of:
locating said recliner BPM apparatus in a relatively isolated and quite environment; and
maintaining a comfortable and relaxed state of the person.

37. The method as set forth in claim 36, wherein maintaining the comfortable and relaxed state of the person comprises avoiding any contact with the person (i.e., such as talking to him or her) with the purpose of inducing him or her into a state of sleeping.

38. The method as set forth in claim 36, wherein maintaining the comfortable and relaxed state of the person comprises engaging in quiet and relaxing conversation with a person for the purpose of calming him or her if he or she exhibits hyperactivity, hypersensitivity or hyperirritability symptoms.

39. The method as set forth in claim 36, wherein maintaining the comfortable and relaxed state of the person comprises choosing a combination of annular range and cyclical rate for rotatably and cyclically moving said reclining chair member about said pivot axis that precludes dizziness or other discomforts in the person.

40. A method for the treatment of a disease or ailment condition through the use of venous blood pressure modulation (BPM) therapy, said method comprising the steps of:
providing a recliner chair BPM apparatus comprising:
a reclining chair member configured to selectively retain a person thereupon in a supine manner generally along a longitudinal axis such that said person's upper torso and head are longitudinally spaced apart from said person's lower extremities;
said recliner chair BPM apparatus further including a trunion assembly for pivotingly supporting said reclining chair member about a transversely disposed pivot axis nominally orthogonal to a vertical plane comprising said longitudinal axis, said longitudinal axis of said reclining chair member then being operative for defining instant rotational orientations of said reclining chair member around said pivot axis;
said recliner chair BPM apparatus further including a controller;
said recliner chair BPM apparatus further including a servomotor that is operatively connected to and driven by a power signal issued from said controller;
a drive mechanism for selectively coupling to said servomotor to said reclining chair member; and
said recliner chair BPM apparatus further including position measuring apparatus operatively connected to said reclining chair member and said controller, said position measuring apparatus issuing a position signal indicative of rotational positions of said longitudinal axis to said controller;
wherein said servomotor is energizable by said controller operating in a closed-loop manner via issuing a controlled power signal to said servomotor such that said position signal can be maintained in close conformance with a command signal representative of a selected program for rotatably and cyclically moving said reclining chair member about said pivot axis;
disposing a person on said reclining chair member so that said person lies supinely thereupon with his or her upper torso and head, and lower extremities spaced apart generally along said longitudinal axis; and
energizing said motor so as to activate said recliner chair BPM apparatus and thereby rotatably move said reclining chair member about said pivot axis through many cycles wherein said person's lower extremities are raised to a level higher than said person's upper torso and head, and vice-versa during each cycle;
wherein said each cycle causes a modulation of the person's venous blood pressure wherein resulting multiple venous blood pressure modulation and/or switching events cause compression and stretching of the veins of the person's upper torso and head, and concomitantly, swelling and shrinking of the veins of the person's lower extremities, and wherein said multiple venous blood pressure modulation and/or switching events result in cumulative internal massaging of arteries and fine arteries, neural fluid flow channels, and lymph fluid flow channels in the person's upper torso and head, and/or lower extremities.

41. The method as set forth in claim 40, further including said drive mechanism being selected from the group comprising a linear drive mechanism and a hydraulic drive mechanism.

42. The method as set forth in claim 40, wherein said command signal is configured in accordance with the method additionally comprising the steps of:
prior to initiating a treatment session, returning said reclining chair member to its nominal initial full upper torso and head-elevated position;
positioning the person in a supine position upon the reclining chair member;
executing a “jog” command signifying that said person has been properly placed on said reclining chair member;
smoothly accelerating said reclining chair member toward the horizontal position such that it reaches a maximum cyclical speed value concomitantly with reaching the horizontal position;
executing a cyclical motion symmetrically about said horizontal position in accordance with selected angular range and cyclical rate values for the duration of the treatment session;
smoothly decelerating said reclining chair member to zero speed at its full upper torso and head-elevated position, beginning with a final crossing of said reclining chair member through the horizontal position as it moves toward the upper torso and head-elevated position; and
removing said person from said reclining chair member in order to terminate said treatment session.

43. The method as set forth in claim 1, wherein a bedridden patient could sleep for extended time periods while avoiding forming bedsores, said method comprising the additional steps of:
enabling said recliner chair BPM apparatus for cyclic operation at a low cyclic rate;
placing the bedridden person on said reclining chair member, and
activating said recliner chair BPM apparatus for cyclic motion.

44. A recliner chair BPM apparatus for implementing therapeutic treatment of a disease or ailment condition through the use of venous blood pressure modulation (BPM) therapy, comprising:
a reclining chair configured to selectively retain a person thereupon in a supine manner generally along a longitudinal axis such that said person's upper torso and head are longitudinally spaced apart from said person's lower extremities;
a trunion assembly for pivotingly supporting said reclining chair about a transversely disposed pivot axis nominally orthogonal to a vertical plane comprising said longitudinal axis, said longitudinal axis of said reclining chair then being operative for defining instant rotational orientations of said reclining chair around said pivot axis;
said recliner chair BPM apparatus further including a motor; and
a drive mechanism for selectively coupling said motor to said reclining chair;
wherein said motor is energizable for rotatably and cyclically moving said reclining chair about said pivot axis.

45. The recliner chair BPM apparatus of claim 44, wherein said reclining chair comprises:
a torso and head-supporting portion;
a thigh-supporting portion; and
a lower extremity-supporting portion comprising an ottoman
wherein the torso and head-supporting portion is attached to the thigh-supporting portion in an angularly variable manner, the lower extremity-supporting portion is similarly attached to the thigh-supporting portion in an angularly variable manner, and the ottoman is longitudinally positionable within the thigh-supporting portion.

46. The recliner chair BPM apparatus of claim 45, wherein said reclining chair further comprises:
a first non-reversible angular adjustment apparatus for varying the angular relationship between said torso and head-supporting and said thigh-supporting portions; and
as second non-reversible angular adjustment apparatus for varying the angular relationship between said thigh-supporting and said attached lower extremity portions.

47. The recliner chair BPM apparatus of claim 46, wherein either of said non-reversible angular adjustment apparatus comprises a hand operated external differential planetary gear set.

48. The recliner chair BPM apparatus of claim 45, wherein said reclining chair member further comprises longitudinal positioning apparatus for positioning said ottoman within said thigh-supporting portion.

49. The recliner chair BPM apparatus of claim 48, wherein said longitudinal positioning apparatus comprises a multi-start leadscrew and mating nut.

50. The recliner chair BPM apparatus of claim 45, wherein said reclining chair member is configured such that when it is disposed in an upright position, its torso and head-supporting portion is angled backwards with reference to the vertical direction, its thigh-supporting portion is oppositely angled upwards with reference to the horizontal direction, and its lower extremity or ottoman portion is angled downwards in a nominally vertical direction.

51. The recliner chair BPM apparatus of claim 45, wherein said reclining chair member is configured such that when it is disposed in an initial reclined position, its torso and head-supporting portion is angled upwards with reference to the horizontal direction by an angle approximately equal to the selected angular range, its thigh-supporting portion is oppositely angled upwards with reference to the horizontal direction by an angle approximately equal to half of the selected angular range, and its lower extremity or ottoman portion is angled downwards with reference to the horizontal direction by an angle approximately equal to half of the selected angular range with said ottoman disposed in an extended position as desired.

52. The recliner chair BPM apparatus of claim 44, wherein the angular range of motion of said longitudinal axis of said reclining chair member, and said person, extends between 10° and 60° in a downward pitch angle direction from said initial reclined position about said pivot axis.

53. The recliner chair BPM apparatus of claim 44, wherein said longitudinal axis of said reclining chair member, and said person, extends about 30° in a downward pitch angle direction from said initial reclined position about said pivot axis.

54. The recliner chair BPM apparatus of claim 44, wherein the cyclical rate utilized for rotatably and cyclically moving said longitudinal axis of said reclining chair member, and said person, about said pivot axis is between 2 cycles/minute and 10 cycles/minute.

55. The recliner chair BPM apparatus of claim 44, wherein the cyclical rate utilized for rotatably and cyclically moving said longitudinal axis of said reclining chair member, and said person, about said pivot axis is about 6 cycles/minute.

56. The recliner chair BPM apparatus of claim 44, wherein the product of the angular range of motion of said longitudinal axis of said reclining chair member and the cyclical rate utilized for rotatably and cyclically moving said longitudinal axis of said reclining chair member is between 90 degree-cycles/minute and 270 degree-cycles/minute.

57. The recliner chair BPM apparatus of claim 44, wherein the product of the angular range of motion of said longitudinal axis of said reclining chair member and the cyclical rate utilized for rotatably and cyclically moving said longitudinal axis of said reclining chair member is about 180 degree-cycles/minute.

58. The recliner chair BPM apparatus of claim 44, wherein said drive mechanism is selected from the group comprising a Scotch yoke mechanism, a crank and connecting rod mechanism, a linear drive mechanism, and a hydraulic drive mechanism.

59. The recliner chair BPM apparatus of claim 44, wherein said drive mechanism is a crank and connecting rod mechanism.

60. A rotational torso reclining mechanism for adjustably varying the reclining angle between thigh, and torso and head supporting portions of a recliner chair, said mechanism comprising a differential planetary gear assembly, wherein:
a first sun gear is fixedly attached to the thigh supporting portion;
a second sun gear is fixedly attached to the torso and head supporting portion; and
at least one differential planetary gear assembly comprising a first planetary gear that is in mesh with said first sun gear and is coaxially fixedly attached to a second planetary gear that is in mesh with said second sun gear, wherein said at least one differential planetary gear assembly is rotationally mounted within a planetary carrier that is constrained for concentric rotational motion around said first and second sun gears.

61. The rotational torso reclining mechanism of claim 60 wherein the planetary carrier is configured as a hand operated knob.

62. The rotational torso reclining mechanism of claim 61 wherein:
said first sun gear has 30 teeth;
said second sun gear has 27 teeth;
said first planetary gear has 15 teeth; and
said second planetary gear has 14 teeth, whereby the ratio between the angle of rotation of said knob and said reclining angle is −27:1.

63. A rotational ottoman elevating mechanism for adjustably varying the elevating angle between thigh, and ottoman portions of a recliner chair, said mechanism comprising a differential planetary gear assembly, wherein:
a first sun gear is fixedly attached to the thigh supporting portion;
a second sun gear is fixedly attached to the ottoman portion; and
at least one differential planetary gear assembly comprising a first planetary gear that is in mesh with said first sun gear and is coaxially fixedly attached to a second planetary gear that is in mesh with said second sun gear, wherein said at least one differential planetary gear assembly is rotationally mounted within a planetary carrier that is constrained for concentric rotational motion around said first and second sun gears.

64. The rotational torso reclining mechanism of claim 63 wherein the planetary carrier is configured as a hand operated knob.

65. The rotational torso reclining mechanism of claim 64 wherein:
said first sun gear has 19 teeth;
said second sun gear has 19 teeth;
said first planetary gear has 14 teeth; and
said second planetary gear has 15 teeth, whereby the ratio between the angle of rotation of said knob and said elevating angle is −14:1.

66. An ottoman extending mechanism for extending an attached and elevated ottoman of an ottoman portion of a recliner chair, said mechanism, comprising:
a hand operated knob driven bevel gear that is rotatably attached to a structural support frame of said ottoman portion with its axis of rotation disposed in an orthogonal manner with reference to the intended extension direction;
a driven bevel gear that is fixedly attached to a leadscrew and rotatably attached to said structural support frame with their common axis of rotation disposed in the intended extension direction;
an ottoman that is slidingly attached to said structural support frame for longitudinal motion in the intended extension direction; and
a nut that threadingly engages said leadscrew and is fixedly attached to said ottoman for driving said ottoman in the intended extension direction.
